(19) United States
(12) Patent Application Publication
(10) Pub. No.: US 2026/0327369 A1
(43) Pub. Date: Oct. 22, 2026

(54) AMINE CATALYSTS FOR POLYURETHANE APPLICATIONS

(71) Applicant: EVONIK OPERATIONS GMBH, Essen (DE)

(72) Inventors: Juan Jesus Burdeniuc, Colmar, PA (US); Thomas Dugan, JR., Allentown, PA (US); Renee Jo Keller, Orwigsburg, PA (US); David VanderSande, Allentown, PA (US); Felix Mühlhaus, Essen (DE)

(73) Assignee: EVONIK OPERATIONS GMBH, Essen (DE)

(21) Appl. No.: 19/487,925

(22) PCT Filed: May 27, 2024
(86) PCT No.: PCT/EP2024/064495

§ 371 Date: Nov. 25, 2025

Related U.S. Application Data
(60) Provisional application No. 63/470,367, filed on Jun. 1, 2023.

(51) Int. Cl. C08G 18/20; B01J 31/02

(52) U.S. Cl. CPC C08G 18/2018; B01J 31/0237; C08G 2110/0008; C08G 2110/0058

(57) ABSTRACT

The present invention relates to amine catalyst compositions, and methods for making the compositions and using the catalyst composition as a gelling or blowing catalyst to make polyurethane foam.

### FIELD OF THE INVENTION

The instant invention relates to tertiary amine catalysts with and without isocyanate reactive groups. The catalyst of the invention without isocyanate-reactive groups are characterized by low vapor pressure compared to industry standards, reducing potential of workers exposure during processing, minimizing issues such as amine exposure and blue haze, while maintaining good catalytic activity and processability. The catalysts of the invention that have isocyanate reactive groups are capable of forming thermally stable covalent bonds with isocyanate being immobilized in the polyurethane polymer and also able to be retained in the polymer phase at temperatures of about 120° C. or higher. In addition, these catalysts are able to provide polyurethane foam material with good physical properties at various isocyanate indexes and are resistant to air oxidation reducing the overall aldehyde and dimethylformamide (DMF) emissions. The instant invention also relates to an efficient chemical process for the synthesis of the tertiary amine catalyst. The instant invention also relates to a method to use these catalysts to make polyurethane foam materials.

### BACKGROUND OF THE INVENTION

The production of cellular polyurethane materials employs a variety of additives and each one of them plays a role in determining the final characteristics and physical properties of the product. Although these additives represent a small percentage in the overall formulation and their emissions are expected to be relatively low, the increasing demand for low volatile organic contents (VOC's) in finished products has placed additional requirements on additives to achieve these lower emissions while maintaining foam performance.

It is well known that conventional manufacturing procedures to make polyurethane foams use additives that are emissive. One possible way to reduce the emissions is by designing relatively small molecules with low vapor pressure to limit the airborne concentration during foam processing while maintaining good catalytic efficiency. The advantage of this approach is that the catalytic activity of these tertiary amines is higher when compared to tertiary amine catalysts having isocyanate-reactive groups and consequently their use level is lower helping managing emissions from finished products.

Another strategy used to reduce emissions from foam is based on introducing functional groups on tertiary amine catalysts making them reactive towards isocyanate group. Using this approach, the tertiary amine catalysts would remain covalently bonded to the polyurethane polymer preventing its release into the environment. This approach might have some limitations because: a) the functionalized tertiary amine can react with isocyanate prematurely causing undesired side effects such as polymer chain termination which would result in poor physical properties, b) excessive cell opening or foam collapse or excessive cross linking which can result in extensive shrinkage and poor dimensional stability, c) poor physical properties particularly when measured after accelerated thermal humid ageing due to the catalyst remaining in contact with the polyurethane material causing its degradation, d) relatively high use levels of catalysts are required due to amine irreversible immobilization in the polyurethane polymer.

Another approach to reduce odor and emissions is based on utilizing materials with high molecular weight and polarity. However, the limitation of this approach is the required higher use level due to the lower catalytic efficiency and molecular mobility.

Products such as dimethylaminopropyl urea, bis(dimethylaminopropyl) urea, bis(dimethylaminopropyl) amine and N,N-bis(dimethylaminopropyl)-N-(2-hydroxypropyl) amine can provide acceptable ambient physical properties as compared to industry standards whereas most conventional reactive catalysts cannot always achieve today's consumer and manufacturer requirements. Using these catalysts can reduce significantly the overall emissions from foam. However, ppm levels of amine catalysts can still be detected in finished articles when emissions are measured according to VDA 278 detection method.

One key feature required for the isocyanate reactive tertiary amine catalyst relates to its ability to form a thermally stable covalent bond with the growing polyurethane polymer. The covalent bond should be stable enough to retain the amine catalyst in the polyurethane polymer when foam sample is heated and emissions are removed from the heated foam by the constant flow of inert gas. Currently, there is a wide variety of functionalized amine polyurethane catalysts capable of reacting with isocyanate during the polymerization process. However, in some cases, foam produced with some of these reactive catalysts can still have some amine emissions because the covalent chemical bonds that hold the amine catalysts into the polyurethane polymer are not sufficiently stable at the temperature of the test.

Without wishing to be bound by any theory or explanation, it is believed that such emissions could result either in the release of the amine catalysts from the polyurethane polymer or in the release of by-products and chemical fragments from the thermal decomposition of the amine-polymer adduct.

In some other cases foam produced with reactive amine catalysts do not have amine emissions because the covalent chemical bonds that holds the amine catalysts into the polyurethane polymer are sufficiently stable at the temperature of the test but the amine is too reactive towards the isocyanate group leaving the catalyst immobilized early on in the polymerization process with the net result that the finished polyurethane product has poor physical properties or it might partially meet certain physical properties while failing others.

In addition to thermal stability, these catalysts need to form hydrolytically stable covalent bonds under a wide variety of conditions and pHs. Hydrolytic stability of the chemical bond between the tertiary amine and the polyurethane polymer plays an important role in applications where the polyurethane foam material is in contact with textiles that can be exposed to moisture and/or water or in applications where foam can directly be exposed to water while in contact with skin. If the hydrolytic stability of the chemical bond between the polymer and the tertiary amine is not sufficient then tertiary amine catalyst can leach from the polyurethane polymer and may allow amines to directly contact skin leading to skin irritation or skin sensitization. In another scenario, if the polyurethane polymer is in direct contact with the surface of another material then leaching of the tertiary amine from the polyurethane polymer to the surface of another material might lead to its damage. If this is not controlled then the finished product will have serious quality issues such as PVC staining, polycarbonate damage, etc.

Thermal stability and catalyst immobilization at lower isocyanate index is an additional performance requirement. In addition to thermal stability at typical indexes such as 90-115 new catalyst needs to be able to form stable covalent bonds with polyurethane polymer made at indexes as low as 65 and no emissions at indexes of 60 or higher. This is a requirement that is difficult to meet because at low isocyanate index there is not sufficient NCO groups able to react with all OH groups from polyols and water so the new tertiary amine catalyst needs to be able to provide simultaneously sufficient catalytic activity to provide good quality foam and effectively compete with OH groups from polyols and water to become part of the polyurethane polymer and be retained in the polymer once the polymerization process is completed.

Finally, managing emissions requires not only strategies for minimizing the emissions of the tertiary amine but also avoid the decomposition of the tertiary amine catalyst and minimize the possibility of causing alternative emissions created by alternative decomposition processes. One such process is the decomposition of tertiary amine by air oxidation with the formation of aldehydes such as formaldehyde, acetaldehyde and propionaldehyde and DMF. New chemical structures must satisfy all the above requirements but in addition they should be air stable during storage as well as when becoming part of the polyurethane polymers. If this requirement is satisfied then formation of aldehydes and other undesired substances such as DMF can be eliminated not only when the polyurethane foam article is produced but also during its usable life.

U.S. Pat. No. 5,859,079 discloses a polyurethane catalyst composition that comprises N,N′-bis(3-dimethylaminopropyl)urea and 3-dimethylaminopropylurea. However when a cured polymer is heated to temperatures as high as 120° C. amine emissions occur. In addition, water contacting foam produced using this catalyst can have an increased alkalinity.

U.S. Pat. No. 6,858,654 discloses a catalyst composition for promoting the polyurethane forming reaction which includes gelling catalysts and blowing catalysts. The gelling catalysts are selected from tertiary aminoalkyl substituted primary or secondary amines and the blowing catalysts are selected from bis(aminoalkyl)ethers comprising alkanol moieties, primary amine moieties, or ureido moieties derived from such primary amine moieties. Foams produced with this catalyst composition are able to provide finished products with no amine emissions, however they cannot meet all physical property requirements.

WO 2016/020139 A1 discloses the use of nitrogen-containing compounds having the pyrrolidine moiety and/or corresponding quaternized and/or protonated compounds for the production of polyurethanes, to compositions containing said compounds and to polyurethane systems, in particular polyurethane foams, obtained using said compounds. The preferred compound is bis(2-pyrrolidinoethyl)ether. However, this compound as well as its related embodiments are characterized by an unpleasant smell, volatility and emissions that confer to the finished polyurethane product undesired characteristics.

US 2017/0152343 A1 discloses the use of nitrogenous compounds and/or corresponding quaternized and/or protonated compounds for production of polyurethanes, to compositions comprising said compounds and also to polyurethane systems, in particular polyurethane foams, obtained using said compounds. The disclosure illustrates various chemical structures made by conventional procedures including the reaction of pyrrolidine with bis(2-chloroethyl)ether to give bis(2-pyrrolidinoethyl)ether with 56% yield. Another approach uses an autoclave procedure using Ruthenium trichloride in the presence of triphenylphosphine to yield bis(2-pyrrolidinoethyl)ether with 64% yield. Although these procedures can provide laboratory scale samples they are not suitable for large scale up due to the toxicity of some of the raw materials or the low yields obtained. Also, the preferred compound is bis(2-pyrrolidinoethyl)ether. However, this compound as well as its related embodiments are characterized by an unpleasant smell, volatility and emissions that confer to the finished polyurethane product undesired characteristics. The preferred compound shows improvement in VOC emissions relative to bis(dimethylaminoethyl)ether (BDMAEE) but emissions are still detected in VOC at 90° C. The emissions are higher when the test is run at 120° C. corresponding to the FOG fraction of the VDA278 emissions test.

WO 2016/020200 A1 discloses the use of nitrogen-containing compounds of a formula (Py-(CR¹R²)ₙ—X and/or corresponding quaternized and/or protonated compounds for the production of polyurethanes, to compositions containing said compounds and to polyurethane systems, in particular polyurethane foams, obtained using said compounds. Among the wide embodiments is shown the structure of 2-[2-(1-pyrrolidinyl)ethoxy]ethyl]-N methylamine, however there is no description of a synthesis or production process methodology. Also, 2-[2-(1-pyrrolidinyl)ethoxy]ethyl]-N-methylamine is not a suitable catalyst to promote the blowing reaction between water and isocyanate.

WO 2016/020140 A2 discloses the use of nitrogen-containing compounds or a corresponding quaternized or protonated compound for the production of polyurethanes, to compositions containing said compounds and to polyurethane systems obtained using said compounds. The application discloses a conventional procedure for the sequential ethoxylation of pyrrolidine to give 2-[2-(1-pyrrolidinyl)ethoxy]ethanol. This procedure as shown in Example 2 (Comparative) produces a low yield of the desired di-ethoxylated compound. The application also discloses a low yield, Ru catalyzed liquid phase synthesis of 2-[2-(1-pyrrolidinyl)ethoxy]ethyl]-N-methylamine in the presence of organophosphorous ligands such as triphenylphosphine without the possibility of catalyst recycling.

WO 2016/020137 A1 discloses the use of nitrogen-containing compounds and/or of corresponding quaternized and/or protonated compounds for producing polyurethanes, to compositions containing said compounds, and to polyurethane systems, in particular polyurethane foams, obtained using the compounds. The composition relates to various pyrrolidine polyethers which can function primarily as emissive or non emissive gelling catalysts.

U.S. Pat. No. 5,874,483 describes conventional isocyanate reactive functionalized tertiary amines having the diethylether backbone made from N,N,N′-trimethyl-bis(aminoethyl)ether. The reactive N—H group provides a point for further functionalization using synthetic techniques such aminopropylation, carbamoylethylation, ethoxylation, and propoxylation. The resulting functionalized ethyl ether amines which contain a reactive site for chemically bonding into the growing polyurethane matrix during polymerization are low emission catalysts. However, their backbones are susceptible to air oxidation that contributes to the buildup over time of aldehyde emissions such as formaldehyde, acetaldehyde and propionaldehyde. Furthermore, the oxidation process might lead to the formation of dimethylformamide.

Thus, there is a need in the art for: 1) processes to make polyurethane foam using amine compositions able to meet the challenges of mechanical and emissions performance including: a) elimination of emissions originating from the amine catalysts under rigorous conditions of temperature at about 120° C.; b) formation of polyurethane polymers wherein the amine catalyst is retained in the polymer when exposed to humidity or water at various temperatures and pHs; c) minimal or no deterioration of other materials such as polycarbonate that come into contact with polyurethane polymer made with the catalyst of the invention; d) overall emission reduction on VOC and FOG when using the catalyst according to the invention; e) significant reduction in use level of tertiary amine catalyst due to its high activity despite its high MW; f) increase in air stability to avoid catalyst decomposition into emissive by products such as formaldehyde, acetaldehyde, propionaldehyde, dimethylformamide, etc.; and g) no emissions and good mechanical performance not only at typical indexes such as 90-115 but also at indexes as low as 65 and no emissions at indexes of 60 or higher; 2) processes to make polyurethane amine catalysts with the desired functionality, chemical architecture and desired application performance that are compatible with scalable production processes where waste and by-product formation is minimized; yields, conversion and rate of production are maximized; 3) providing new compositions of matter including contact compositions that can enable the requirements of 1) and 2).

### BRIEF SUMMARY OF THE INVENTION

There is a need in the art for foam manufacturing methods that can use additives that are stable towards oxidation. In some applications such as flexible slabstock polyurethane foam, polyurethane foam for automotive interiors and also in residential spray foam applications there is a need for polyurethane manufacturing methods that use amine catalysts with no amine emissions that can perform as well as the conventional emissive catalysts while providing optimum physical properties, low odor, stability to long term air oxidation and reduced or no aldehyde and DMF emissions. There is also a need for methods to synthesize and manufacture such amine catalysts in efficient ways as to maximize yields, minimize waste and optimize production rates. There is also a need for methods to make these tertiary amine catalysts with reduced level of impurities that can be detrimental to the overall above mentioned desired performance. Impurities can have negative impact on emissions, odor, EH&S profile as well as mechanical performance depending on their characteristics.

In one embodiment, the instant invention solves problems associated with conventional methods to make polyurethane foam by providing a process using an isocyanate reactive tertiarly amine catalyst able to reduce the amine emissions, reduce odorous emmanations and reduce the rate of formation of odorous VOC during the lifetime of the polyurethane article improving the final user's experience.

The instant invention also solves problems associated with catalyst leaching from foam during water contact and thereby avoiding the exposure of end users to amines. The invention further solves problems of material deterioration when certain materials are in contact with polyurethane polymer (e.g., discoloration, staining, among other problems that can be caused by catalyst migration from polyurethane foam during extreme environmental conditions of heat and humidity). The invention solves these problems while providing foam products with optimum physical properties and foam rate of rise kinetics.

In one aspect of the invention, the catalyst composition comprises at least one tertiary amine with the formula:

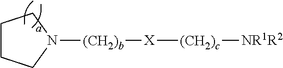

where a=1 or 2; b and c are independently 2 or 3; and X═O or N—CH₃; and R¹═R²═CH₃, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

In one aspect, the invention provides a method for the manufacturing of a catalyst composition comprising at least one tertiary amine with the formula:

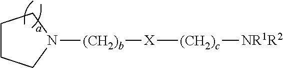

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or 1═H and R²═—(CH₂)₂CN, or R¹ and R²═—(CH₂)₂CN.

In another aspect, the invention provides a method for making a polyurethane foam comprising reacting at least one isocyanate and at least one polyol in the presence of a catalyst composition comprising at least one tertiary amine with the formula:

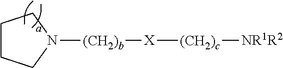

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or 1═H and R²═—(CH₂)₂CN, or R¹ and R²═—(CH₂)₂CN.

In one aspect of the invention the catalyst composition eliminates emissions originating from the tertiary amine catalysts under rigorous conditions of temperature at about 120° C.

In another aspect of the invention, the catalyst composition catalyzes the formation of polyurethane polymers wherein the tertiary amine catalyst is retained in the polymer when exposed to humidity or water at various temperatures and pHs.

In a further aspect of the invention minimal or no deterioration of other materials such as polycarbonate that come into contact with polyurethane polymer are made with the tertiary amine catalyst of the invention.

In another aspect of the invention, the catalyst composition reduces the overall emission of VOC and FOG when making polyurethane foams according to the invention.

Furthermore, there is a significant reduction in use level of tertiary amine catalyst due to its high activity.

The tertiary amine used according to the invention also provides a significant reduction of emissions resulting from the air oxidation of the catalyst over time.

One aspect of the instant invention relates to using the catalyst composition to produce polyurethane foam having desirable characteristics and low chemical emissions over a wide range of isocyanate indexes including indexes as low as about 65 and as low as 60.

In another aspect, there is sufficient hydrolytic stability to maintain the catalyst covalently bound to the foamed polymer without leaching of tertiary amine catalyst when foam is exposed to water or aqueous solutions even at temperatures higher than ambient (e.g., temperature range about 25° C. to about 90° C.).

The tertiary amine catalyst according to the invention can also provide a stable contact interface between the polyurethane polymer and other polymers (polycarbonate, PVC, etc.) with minimal migration of tertiary amine catalyst from polyurethane polymer to other polymer surfaces yielding no noticeable polymer deterioration at the point of contact even under conditions of heat and humidity.

In one aspect of the invention, the catalyst composition of the invention can also be used in combination with certain amine blowing catalysts such as at least one member selected from the group consisting of N,N,N′-trimethyl-N′-3-aminopropyl-bis(aminoethyl) ether, 2-[N-(dimethylaminoethoxyethyl)-N-methylamino]ethanol, and N,N,N′-trimethyl-N′-(2-hydroxyethyl)-bis(aminoethyl) ether.

In another aspect of the invention, the catalyst composition of the invention can be used in combination with certain amine gelling catalysts such as at least one member selected from the group consisting of N,N-bis(3-dimethylaminopropyl)-N-(2-hydroxypropyl) amine; N,N-dimethyl-N′,N′-bis(2-hydroxypropyl)-1,3-propylenediamine; dimethylaminopropylamine (DMAPA); N-methyl-N-2-hydroxypropylpiperazine, bis-dimethylaminopropyl amine (POLYCAT® 15), dimethylaminopropyl urea and N,N′-bis(3-dimethylaminopropyl) urea (DABCO® NE1060, DABCO® NE1070, DABCO® NE1080 and DABCO® NE1082), 1,3-bis(dimethylamino)-2-propanol, 6-dimethylamino-1-hexanol, N-(3-aminopropyl)imidazole, N-(2-hydroxypropyl)imidazole, N,N′-bis(2-hydroxypropyl) piperazine, N-(2-hydroxypropyl)-morpholine, and N-(2-hydroxyethylimidazole), 2-hydroxymethyl-1,4-diazabicyclo[2.2.2]octane, N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; N,N-bis(3-dimethylaminopropyl)-N-[(2-hydroxypropyl)-3-aminopropyl]amine; N,N-bis(dimethylaminopropyl)-N-(3-aminopropyl)-amine; N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; and N,N-bis(3-dimethylaminopropyl)-N-[(2-hydroxypropyl)-3-aminopropyl]amine.

In one aspect of the invention, the catalyst composition has a dimethylformamide (DMF) concentration between 0 ppm to 40 ppm.

In one aspect, the invention provides a new composition of matter useful in processes for making polyurethane foams.

A further aspect of the invention relates to a process for making polyurethane foams by using the inventive catalyst composition.

Another aspect of the invention relates to an improved process for the selective conversion of cycloalkylamino ether alcohols to cycloalkylamino ether amines and cycloalkylamino ether amine nitriles.

In one aspect, the invention is a method for converting a cycloalkylamino ether alcohol to a cycloalkylamino ether amine, the method comprising contacting a catalyst comprising at least one of Zinc oxide and a Zinc salt, and at least one of copper oxide and a copper salt, with a vapor phase mixture comprising the cycloalkylamino ether alcohol and an amine in the presence of hydrogen.

In one aspect, the invention is a method for converting cycloalkylamino ether amine into cycloalkylamino ether amine nitriles.

### BRIEF DESCRIPTION OF THE DRAWINGS

FIG. 1 shows the evaluation of color change of N,N,N-trimethyl-N-3-aminopropyl-bis(aminoethyl)ether during air exposure at 50° C. at 0 days, 2 days, 4 days, and 7 days.

FIG. 2 shows the evaluation of color change of 2-[2-(1-pyrrolidinyl)ethoxy]ethyl-N-methyl-N-(3-aminopropyl)-amine (PyEEAPMA) during air exposure at 50° C. at 0 days, 2 days, 4 days, and 7 days.

### DETAILED DESCRIPTION OF THE INVENTION

The instant invention relates to amine catalyst compositions, and methods for making the compositions and using the catalyst composition as a gelling or blowing catalyst to make polyurethane foam. The inventive catalyst can be used to: a) minimize foam emissions without compromising foam physical properties; b) provide foam that is hydrolytically stable with no increase in pH on the aqueous phase when foam is exposed to water or moisture under various extreme environmental conditions; c) no damage to materials in contact to polyurethane as a result of catalyst not migrating out of the polyurethane polymer (for example when polycarbonate surfaces are exposed to polyurethane foam under various extreme conditions of temperature and humidity); d) optimum physical properties such as target density (ASTM 3574-A), air flow (ASTM 3574-G), ILDs (indentation load deflection method ASTM 3574-B1), support factor (ASTM 3574-B1) and resilience (ASTM 3574-H) and e) significant reduction in gelling amine catalyst use level due to its high catalytic activity.

Included in the invention are flexible molded foams characterized by excellent physical properties such as target density (ASTM 3574-A) with range of about 28 to about 80 kg/m³, air flow (ASTM 3574-G) with range of about 40 to about 120 L/M, ILDs (indentation load deflection method ASTM 3574-B1) with range of about 150 to about 600 N, support factor (ASTM 3574-B1) with range of about 2.5 to about 3.5, preferably about 3, and resilience (ASTM 3574-H) range of about 40 to about 80%. In one aspect of the invention a desirable foam has a Tensile/HA Tensile/Elongation/HA Elongation=DIN 53571—Range of about 80 to about 200%, a 50% Compression Set=ASTM D3574-D—Range of about 1 to about 20%, a HA Compression Set=ASTM D3574-J1 and J2—Range of about 5 to about 15%, and Tear=ASTM D3574-F—Range of about 150 to about 400.

In one aspect of the invention, the inventive catalyst composition comprises at least one tertiary amine with the formula:

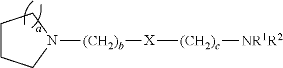

where a=1 or 2; b and c are independently 2 or 3; and X═O or N—CH₃; and R¹═R²═CH₃, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

Preferably, the at least one tertiary amine is selected from the group consisting of 2-[2-(1-pyrrolidinyl)ethoxy]ethyl-N,N-dimethyl amine; 2-[2-(1-pyrrolidinyl)ethoxy]ethyl-N-methyl-N-ethyl-anine; 2-[2-(1-pyrrolidinyl)ethoxy]ethyl-N-methy-N-propyl-amine; 2-[2-(1-pyrrolidinyl)ethoxy]ethyl-N-methyl-N-isopropyl-amine; 2-[2-(1-pyrrolidinyl)ethoxy]ethyl-N-methyl-N-(n-butyl)-amine; 2-[2-(1-pyrrolidinyl)ethoxy]ethyl-N-methyl-N-(sec-butyl)-amine; 2-[2-(1-pyrolidinyl)ethyoxy]ethyl-N-methyl-N-(iso-butyl)-amine; 2-[2-(1-pyrrolidinyl)ethoxy]propy-N,N-dimethyl amine; 2-[2-(1-pyrrolidinyl)ethoxy]propy-N-methyl-N-ethyl-amine; 2-(1-pyrrolidinyl)ethoxy]propyl-N-methyl-N-propyl-amine; 2-[2-(1-pyrrolidinyl)ethoxy]propyl-N-methy-N-isopropyl-amine; 2-[2-(1-pyrrolidinyl)ethoxy]propyl-N-methyl-N-(sec-butyl-amine; 2-[2-(1-pyrrolidinyl)ethoxy]propyl-N-methyl-N-(sec-butyl)-amine; 2-[2-(1-pyrrolidinyl)ethoxy]propyl-N-2-2(1-pyrrolidinyl)propoxy]ethyl-N,N-diethyl amine; 22-(1-pyrrolidinyl)propoxy]eethyl-N-methyl-N-ethyl-amine; 2[-2-(1-pyrrolidinyl)propoxy]ethyl-N-methyl-N-propylamine; 2[-2-(1-pyrrolidinyl)propoxy]ethyl-N-methyl-N-isopropyl-amine; 2-[2-(1-pyrrolidinyl)propoxy]ethyl-N-methyl-N-(n-butyl)-amine; 2-[2-(1-pyrrolidinyl)propoxy]ethyl-N-methyl-N-(secbutyl)-amine; 2-[2-(1-pyrrolidinyl)propoxy]ethyl-N-methyl-N-(iso-butyl)-amine; 2-[2-(1-pyrrolidinyl)propoxy]propy-N,N-dimethyl amine; 2-[2-(1-pyrrolidinyl)propoxy]propy-N-methyl-N-ethyl-amine; 2-[2-(1-pyrrolidinyl)propoxy]propyl-N-ethyl-N-propylamine; 2-[2-(1-pyrrolidinyl)propoxy]propyl-N-methyl-N-isopropyl-amine; 2-[2-(1-pyrrolidinyl)propoxy]propyl-N-methyl-N-(n-butyl)-amine; 2-[2-(1-pyrrodinyl)propoxy]propyl-N-methyl-N-(sec-butyl)-amine; 2-[2-(1-pyrrolidinyl)propoxy]propy-N-methyl-N-(iso-butyl)-amine; 2-[2-(1-pyrrolidinyl)ethoxy]ethyl-N-methyl-N-(2-cyanoethyl)-amine; 2-[2-(1-pyrrolidinyl)ethoxy]ethyl-N-methyl-N-(3-aminopropyl)amine; 2-[2-(1-pyrrolidinyl)ethoxy]ethyl-N-ethyl-N-(2-aminoethyl)-amine; 2-[2-(1-pyrrolidin-yl)ethoxy]propyl-N-methyl-N-(2-cyanoethyl)-amine; 2-[2-(1-pyrrolidinyl-)ethoxy]propy-N-methy-N-(3-aminopropyl-amine; 2-[2-(1-pyrrolidinyl)ethoxy]propyl-N-methy-N-(2-aminoethyl)amine; 2[-2-(1-pyrrolidinyl)propoxy]propyl-N-methyl-N-(3-aminopropyl)-amine; 2-[2-(1-pyrrolidinyl)propoxy]propyl-N-methyl-N-(2-aminoethyl-amine; 2-[2-(1-pyrrolidinyl)propoxy]ethyl-N-methyl-N-(3-aminopropyl)-amine; 2-[2-(1-pyrrolidinyl)propoxy]ethyl-N-methyl-N1-(2-aminoethyl)amine; 2-[2-(1-pyrrolidinyl)ethoxy]ethyl-N-methy-N-(2-cyanoethyl-amine; 2-[2-(1-pyrrolidinyl-)ethoxy]ethyl-N-(2-cyanoethyl)-amine; 2-[2-(1-pyrrolidinyl)ethyl]propyl-N-methyl-N-(2-cyanoethyl)-nine; 2-[2-(1-pyrrolidinyl)ethoxy]propyl-N-(2-cyanoethyl)-amine; 2-[2-(1-pyrrolidinyl)propoxy]propyl-N-methyl-N-(2-cyanoethyl)-amine; 2-[2-(1-pyrrolidinyl)propoxy]propyl-N-(2-aminoethyl)-amine; 2-[2-(1-pyrrolidinyl)propoxy]ethyl-N-methyl-N-(2-cyanoethyl)-amine; 2-[2-(1-pyrolidinyl)propoxy]ethyl]-N-(2-aminoethyl)-amine, 2-[2-(1-piperidinyl)ethoxy]ethyl-N,N-dimethyl amine; 2-[2-(1-piperidinyl)ethoxy]ethyl-N-methyl-N-ethyl-amine; 2-[2-(1-piperidinyl)ethoxy]ethyl-N-methyl-N-propyl-amine; 2-[2-(1-piperidinyl)ethoxy]ethyl-N-methyl-N-isopropyl-amine; 2-[2-(1-piperidinyl)ethoxy]ethyl-N-methyl-N-(n-butyl)-amine; 2-[2-(1-piperidinyl)ethoxy]ethyl-N-methyl-N-(sec-butyl)-amine; 2-[2-(1-piperidinyl)ethoxy]ethyl-N-methyl-N-(iso-butyl)-amine; 2-[2-(1-piperidinyl)ethoxy]propyl-N,N-dimethyl amine; 2-[2-(1-piperidinyl)ethoxy]propyl-N-methyl-N-ethyl-amine; 2-[2-(1-piperidinyl)ethoxy]propyl-N-methyl-N-propyl-amine; 2-[2-(1-piperidinyl)ethoxy]propyl-N-methyl-N-isopropyl-amine; 2-[2-(1-piperidinyl)ethoxy]propyl-N-methyl-N-(n-butyl)-amine; 2-[2-(1-piperidinyl)ethoxy]propyl-N-methyl-N-(sec-butyl)-amine; 2-[2-(1-piperidinyl)ethoxy]propyl-N-methyl-N-(iso-butyl)-amine; 2-[2-(1-piperidinyl)propoxy]ethyl-N,N-dimethyl amine; 2-[2-(1-piperidinyl)propoxy]ethyl-N-methyl-N-ethyl-amine; 2-[2-(1-piperidinyl)propoxy]ethyl-N-methyl-N-propyl-amine; 2-[2-(1-piperidinyl)propoxy]ethyl-N-methyl-N-isopropyl-amine; 2-[2-(1-piperidinyl)propoxy]ethyl-N-methyl-N-(n-butyl)-amine; 2-[2-(1-piperidinyl)propoxy]ethyl-N-methyl-N-(sec-butyl)-amine; 2-[2-(1-piperidinyl)propoxy]ethyl-N-methyl-N-(iso-butyl)-amine; 2-[2-(1-piperidinyl)propoxy]propyl-N,N-dimethyl amine; 2-[2-(1-piperidinyl)propoxy]propyl-N-methyl-N-ethyl-amine; 2-[2-(1-piperidinyl)propoxy]propyl-N-methyl-N-propyl-amine; 2-[2-(1-piperidinyl)propoxy]propyl-N-methyl-N-isopropyl-amine; 2-[2-(1-piperidinyl)propoxy]propyl-N-methyl-N-(n-butyl)-amine; 2-[2-(1-piperidinyl)propoxy]propyl-N-methyl-N-(sec-butyl)-amine; 2-[2-(1-piperidinyl)propoxy]propyl-N-methyl-N-(iso-butyl)-amine; 2-[2-(1-piperidinyl)ethoxy]ethyl-N-methyl-N-(3-aminopropyl)-amine; 2-[2-(1-piperidinyl)ethoxy]ethyl-N-methyl-N-(2-aminoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(3-aminopropyl)-amine; 2-[2-(1-piperidinyl)ethoxy]propyl-N-methyl-N-(2-aminoethyl)-amine; 2-[2-(1-piperidinyl)propoxy]propyl-N-methyl-N-(3-aminopropyl)-amine; 2-[2-(1-piperidinyl)propoxy]propyl-N-methyl-N-(2-aminoethyl)-amine; 2-[2-(1-piperidinyl)propoxy]ethyl-N-methyl-N-(3-aminopropyl)-amine; 2-[2-(1-piperidinyl)propoxy]ethyl-N-methyl-N-(2-aminoethyl)-amine; 2-[2-(1-piperidinyl)ethoxy]ethyl-N-methyl-N-(2-cyanoethyl)-amine; 2-[2-(1-piperidinyl)ethoxy]ethyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-(2-cyanoethyl)-amine; 2-[2-(1-piperidinyl)propoxy]propyl-N-methyl-N-(2-cyanoethyl)-amine; 2-[2-(1-piperidinyl)propoxy]propyl-N-(2-aminoethyl)-amine; 2-[2-(1-piperidinyl)propoxy]ethyl-N-methyl-N-(2-cyanoethyl)-amine; and 2-[2-(1-piperidinyl)propoxy]ethyl]-N-(2-aminoethyl)-amine.

In one aspect, the invention provides a method for the manufacturing of a catalyst composition comprising at least one tertiary amine with the formula:

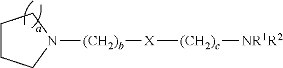

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

Preferably in one embodiment of the method, X═O and the method comprises converting cyclic-amines to cycloamino-alkylether amines by the following reaction sequence: a) alkoxylation of a cyclic-amine to give cycloamine-alkoxyalcohol; and b) conversion of the cycloamine-alkoxyalcohol to the cycloamine-alkoxy-alkylamine.

Preferably in one embodiment of the method, the method comprises alkoxylation of pyrrolidine to 2-[2-(1-pyrrolidinyl)ethoxy]ethanol and the conversion of 2-[2-(1-pyrrolidinyl)ethoxy]ethanol to 2-[2-(1-pyrrolidinyl)ethoxy]ethyl-N,N-dimethyl-amine.

Preferably in another embodiment of the method, X═N—CH₃ and the method comprises converting cyclic-amines to cycloamino-alkylether-amine-nitriles and to cycloamino-alkylether-amines having a primary or secondary amine functionality by the following reaction sequence: a) alkoxylation of a cyclic-amine to give cycloamine-alkoxyalcohol; b) conversion of the cycloamine-alkoxyalcohol to the cycloamine-alkoxy-alkylamine; c) conversion of the cycloamine-alkoxy-alkylamine to cycloamino-alkyl-ether-amine-nitriles; d) conversion of the cycloamino-alkyl-ether-amine-nitriles to cycloamino-alkyl-ether amine having a primary amine functionality.

Preferably in one embodiment of the method, the method comprises converting pyrrolidine to 2-[2-(1-pyrrolidinyl)ethoxy]ethyl-N-methyl-N-(3-aminopropyl)-amine by the following sequence: a) pyrrolidine is converted to 2-[2-(1-pyrrolidinyl)ethoxy]ethanol by contacting pyrrolidine with ethylene oxide (EO) utilizing a semi-batch procedure where 1) the pyrrolidine/EO molar ratio is from 0.90 to 1.10 and preferably 0.95 to 1.05 followed by 2) the resulting pyrrolidine-EO adduct of 1) is further reacted with EO where the final pyrrolidine/EO molar ratio is from 1.80 to 2.20 and preferably 1.9 to 2.1 in the presence of an alkoxylation catalyst such as KOH; b) reaction of 2-[2-(1-pyrrolidinyl)ethoxy]ethanol with methylamine under hydrogen pressure in a continuous reaction mode over a catalyst containing Cu/Zn supported on alumina (A₂O₃) with or without a metal catalyst promoter at conditions such that the reactants are in the vapor phase to yield 2-[2-(1-pyrrolidinyl)ethoxy]ethyl-N-methyl-amine; c) reaction of the sec-amine group of 2-[2-(1-pyrrolidinyl)ethoxy]ethyl-N-methyl-amine with acrylonitrile to give 2-[2-(1-pyrrolidinyl)ethoxy]ethyl-N-methyl-(2-cyanoethyl)-amine; d) hydrogenation of the product obtained in c) to give the corresponding primary amine containing finished product 2-[2-(1-pyrrolidinyl)ethoxy]ethyl-N-methyl-N-(3-aminopropyl)-amine.

Preferably in one embodiment of the method, the method comprises converting pyrrolidine to 2-[2-(1-pyrrolidinyl)ethoxy]ethyl-N,N-dimethylamine by the reaction of 2-[2-(dimethylamino)ethoxy]ethanol with pyrrolidine under hydrogen pressure in a continuous reaction mode over a catalyst containing Cu/Zn supported on alumina (Al₂O₃) with or without a metal catalyst promoter at conditions such that the reactants are in the vapor phase.

In another embodiment, the conversion of alcohol to amine can be carried out in a reactor with a suitable configuration which may be any of a variety of types and sizes as soon as there is good contact between the vaporized feeds and catalyst. The reactions may be most simply carried out in a fixed bed, single tube, adiabatic reactor but other configurations that may be used include fixed bed reactors containing multiple tubes, with or without cooling, and fluidized bed systems. Cycloamino, ether-alcohols and amines may be fed to the reactor by any of various means known in the art including for example a metering pump from two separate feeds. Alternatively, the amine/cycloamine, alcohol or amine-alcohol may be combined prior to introduction into the reactor. Hydrogen is co-fed to the reactor via a flow controller or other metering device to maintain the catalyst in an active reduced state. These reactants, either separately or combined, must be preferably vaporized and/or heated to a sufficient temperature to ensure that they are preferably in the vapor phase prior to contacting the catalyst. The products of the reaction are then condensed by cooling and may then be separated via distillation or other techniques known in the chemical engineering art.

The metal catalysts utilized for the conversion of the alcohol to amine are any of a broad class of Cu/Zn materials. The catalyst will be reduced prior to performing the conversion of amino-ether-alcohol to amino-ether-amine. Such reduction may be by any chemical means. Most of the reduction may be performed by contacting the catalyst with hydrogen at an elevated temperature. The hydrogen may be introduced as H₂ gas, or it may be formed by interaction of the catalyst with an organic compound, for example isopropyl alcohol. The reducing agent is used to pre-treat the catalyst prior to use, and its introduction into the reactor is continued on either an intermittent or continuous basis during the amination reaction, to keep the catalyst in an active state. Preferred catalysts for use comprise a copper salt and/or oxide and a zinc salt and/or oxide. The weight ratio of Cu/Zn (as the metals) may be 0.3 to 6, preferably 0.4 to 3, more preferably 0.45 to 2.75. The copper and zinc salts or oxides may include as nonlimiting examples carbonates, hydroxides, and/or salts of carboxylic acids. In one exemplary embodiment, the catalyst comprises 20 to 70 wt % of CuO and 20 to 65 wt % of ZnO. In another exemplary embodiment, the catalyst comprises CuO, ZnO, Al₂O₃, and SiO₂. The content of SiO₂ in the catalyst may range from 0 to 40% by weight, preferably 0 to 10%. The content of Al₂O₃ in the catalyst may range from 0 to 40% by weight, preferably 0 to 20%. Other materials may be present in the catalyst as well. In some cases the catalyst has a Cu/Zn ratio of about 0.8. Also, since the vapor phase processing requires a lower reactor pressure and operates in a continuous mode, reactor construction and operation may be simplified. Copper leaching from the catalyst is essentially eliminated in vapor processing, resulting in longer catalyst life, minimal copper contaminants in the product, and alleviating need for equipment cleaning to remove deposited copper. The presence of one or more promoters chosen from the Group 1 or 2 elements or early lanthanides, to the base Cu/Zn catalysts, can result in improvements in catalyst selectivity for the desired reaction vs. side reactions. Preferred promoters may be chosen from the alkali metals (Group 1 of the periodic table), alkaline earth metals (Group 2 of the periodic table), or early lanthanides (Group 3 of the periodic table, particularly those elements ranging from atomic number 57, lanthanum, to atomic number 65 terbium, with the exception of element number 61, promethium). Examples of preferred promoters include lithium, sodium, potassium, rubidium, cesium, magnesium, calcium, strontium, barium, lanthanum, cerium, praseodymium, neodymium, samarium, europium, gadolinium, and terbium. More preferred promoters include sodium, potassium, rubidium, cesium, magnesium, calcium, strontium, barium, lanthanum, cerium, praseodymium, neodymium, and samarium. Most preferred promoters are potassium, rubidium, cesium, magnesium, calcium, strontium, lanthanum, cerium, and praseodymium. Promoters may be present in the catalyst at a level of 0.05 to 5 wt %, preferably 0.2 to 2 wt %, most preferably, 0.3 to 1.5 wt %.The reaction conditions can be carried out at temperatures in the range of 120° to 300° C. and pressures in the range of 0 to 500 psig (101 to 3549 kPa). We have found that the process operates quite effectively in the range of 180° to 220° C. and 0 to 100 psig (101 to −700 kPa), although not restricted to these ranges. The pressure ranges from 40 to 80 psig (377 to 653 kPa). The amine and the cycloalkylamino ether alcohol can be co-fed to the reactor over a broad ratio range. The molar ratio of amine to cycloamino alkylether alcohol can be from 0.3 to 8, preferably from 1 to 4. If hydrogen is fed to the reactor, it is fed at a molar ratio of 1 to 8, preferably 2 to 5, relative to amino ether alcohol. Rates of addition of amine and amino ether alcohol to the reactor vary according to a variety of factors, including the exact composition of these materials, the exact catalyst used, the temperature of the reactor, the pressure, and other variables. Determination of optimum conditions for any particular combination of these parameters is well within the ability of the skilled artisan.

In another embodiment, the invention provides a method for making a polyurethane foam comprising reacting at least one isocyanate and at least one polyol in the presence of a catalyst composition comprising at least one tertiary amine with the formula:

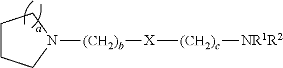

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

One embodiment of the invention relates to a process to make polyurethane foam materials of the various types including flexible, rigid and semi-rigid which can be made using a combination of tertiary amine gelling catalysts in combination with the catalyst of the invention having no isocyanate reactive groups comprising 2-[2-(1-pyrrolidinyl)ethoxy]ethyl-N,N-dimethyl amine; [2-(1-pyrrolidinyl)ethoxy]ethyl-N-methyl-N-ethyl-amine; 2-[2-(1-pyrrolidinyl)ethoxy]ethyl-N-methyl-N-propyl-amine; 2-[2-(1-pyrrolidinyl)ethoxy]ethyl-N-methyl-N-isopropyl-amine; 2-[2-(1-pyrrolidinyl)ethoxy]ethyl-N-methyl-N-(n-butyl)-amine; 2-[2-(1-pyrrolidinyl)ethoxy]ethyl-N-methyl-N-(secbutyl)amine; 2[2-(1-pyrrolidinyl)ethoxy]ethyl-N-methy-N-(iso-butyl)-amine; 2-[2-(1-pyrrolidinyl)ethoxy]propy-N,N-diethyl amine; 2-[2-(1-pyrrolidinyl)ethoxy]propyl-N-methyl-N-ethyl-amine; 2[-2-(1-pyrrolidinyl)ethoxy]propyl-N-methyl-N-propyl-amine; 2-[2-(1-pyrrolidinyl)ethoxy]propyl-N-methyl-N-isopropyl-amine; 2-[2-(1-pyrrolidinyl)ethoxy]propyl-N-methyl-N-(n-butyl)-amine; 2-[2-(1-pyrrolidinyl)ethoxy]propyl-N-methyl-N-(secbutyl)-amine; 2-[2-(1-pyrrolidinyl)ethoxy]propyl-N-methyl-N-(iso-butyl)-amine; 2-[2-(1-pyrrolidinyl)propoxy]ethyl-N,N-dimethyl amine; 2-[2-(1-pyrrolidinyl)propoxy]ethyl-N-methyl-N-ethyl-amine; 2-[2-(1-pyrrolidinyl)propoxy]ethyl-N-methyl-N-propyl-amine; 2-[2-(1-pyrrolidinyl)propoxy]ethyl-N-methyl-N-isopropyl-amine; 2-[2-(1-pyrrolidinyl)propoxy]ethyl-N-methyl-N-(n-butyl)-amine; 22-(1-pyrrolidinyl)propoxy]ethyl-N-methyl-Nsec-butyl)-amine; 2-[2[-1-pyrrolidinyl)propoxy]ethyl-N-methyl-N-(iso-butyl)-amine; 2-[2-(1-pyrrolidinyl)propoxy]propyl-N,N-dimethyl amine; 2-[2-(1-pyrrolidinyl)propoxy]propyl-N-methyl-N-ethyl-amine; 2-[2-(1-pyrrolidinyl)propoxy]propyl-N-methyl-N-propyl-amine; 2-[2-(1-pyrrolidinyl)propoxy]propyl-N-methyl-N-isopropyl-amine; 2-[2-(1-pyrrolidinyl)propoxy]propyl-N-methy-N-(n-butyl)-amine; 2-[2-(1-pyrrolidinyl)propoxy]propyl-N-methy-N-(sec-butyl)-amine; 2-[2-(1-pyrrolidinyl)propoxy]propyl-N-methyl-N-(iso-butyl)-amine; 2-[2-(1-piperidinyl)ethoxy]ethyl-N,N-dimethyl amine; 2-[2-(1-piperidinyl)ethoxy]ethyl-N-methyl-N-ethyl-amine; 2-[2-(1-piperidinyl)ethoxy]ethyl-N-methyl-N-propyl-amine; 2-[2-(1-piperidinyl)ethoxy]ethyl-N-methyl-N-isopropyl-amine; 2-[2-(1-piperidinyl)ethoxy]ethyl-N-methyl-N-(n-butyl)-amine; 2-[2-(1-piperidinyl)ethoxy]ethyl-N-methyl-N-(sec-butyl)-amine; 2-[2-(1-piperidinyl)ethoxy]ethyl-N-methyl-N-(iso-butyl)-amine; 2-[2-(1-piperidinyl)ethoxy]propyl-N,N-dimethyl amine; 2-[2-(1-piperidinyl)ethoxy]propyl-N-methyl-N-ethyl-amine; 2-[2-(1-piperidinyl)ethoxy]propyl-N-methyl-N-propyl-amine; 2-[2-(1-piperidinyl)ethoxy]propyl-N-methyl-N-isopropyl-amine; 2-[2-(1-piperidinyl)ethoxy]propyl-N-methyl-N-(n-butyl)-amine; 2-[2-(1-piperidinyl)ethoxy]propyl-N-methyl-N-(sec-butyl)-amine; 2-[2-(1-piperidinyl)ethoxy]propyl-N-methyl-N-(iso-butyl)-amine; 2-[2-(1-piperidinyl)propoxy]ethyl-N,N-dimethyl amine; 2-[2-(1-piperidinyl)propoxy]ethyl-N-methyl-N-ethyl-amine; 2-[2-(1-piperidinyl)propoxy]ethyl-N-methyl-N-propyl-amine; 2-[2-(1-piperidinyl)propoxy]ethyl-N-methyl-N-isopropyl-amine; 2-[2-(1-piperidinyl)propoxy]ethyl-N-methyl-N-(n-butyl)-amine; 2-[2-(1-piperidinyl)propoxy]ethyl-N-methyl-N-(sec-butyl)-amine; 2-[2-(1-piperidinyl)propoxy]ethyl-N-methyl-N-(iso-butyl)-amine; 2-[2-(1-piperidinyl)propoxy]propyl-N,N-dimethyl amine; 2-[2-(1-piperidinyl)propoxy]propyl-N-methyl-N-ethyl-amine; 2-[2-(1-piperidinyl)propoxy]propyl-N-methyl-N-propyl-amine; 2-[2-(1-piperidinyl)propoxy]propyl-N-methyl-N-isopropyl-amine; 2-[2-(1-piperidinyl)propoxy]propyl-N-methyl-N-(n-butyl)-amine; 2-[2-(1-piperidinyl)propoxy]propyl-N-methyl-N-(sec-butyl)-amine; 2-[2-(1-piperidinyl)propoxy]propyl-N-methyl-N-(iso-butyl)-amine; or mixtures thereof.

Another embodiment of the invention relates to low or no amine emissions polyurethane foams of the various types including flexible, rigid and semi-rigid which can be made using a combination of certain isocyanate reactive tertiary amine gelling catalysts in combination with an isocyanate reactive catalyst of the invention comprising 2-[2-(1-pyrrolidinyl)ethoxy]ethyl-N-methyl-N-(2-cyanoethyl)amine; 2-[2-(1-pyrrolidinyl)ethoxy]ethyl N-methyl-N-(3-aminopropyl)-amine; 2-[2-(1-pyrrolidinyl)ethoxy]ethyl-N-methyl-N-(2-aminoethyl)-amine; 2-[2-(1-pyrrolidinyl)ethoxy]propyl-N-methyl-N-(2-cyanoethyl)-amine; 2-[2-(1-pyrrolidinyl)ethoxy]propyl-N-methyl-N-(3-aminopropyl)amine; 2-[2-(1-pyrrolidinyl)ethoxy]propyl-N-methy-N-(2-aminoethyl)amine; 2-[2-(1-pyrrolidinyl)propoxy]propyl-N-methyl-N-(3-aminopropyl)-amine; 2-[2-(1-pyrrolidinyl)propoxy]propyl-N-methyl-N-(2-aminoethyl)-amine; 2-[2-(1-pyrrolidinyl)propoxy]ethyl-N-methyl-N-(3-aminopropyl)-amine; 2-[2-(1-pyrrolidinyl)propoxy]ethyl-N-methy-N-(2-aminoethyl)-amine; 2-[2-(1-pyrrolidinyl)ethoxy]ethyl-N-methy-N-2-cyanoethyl)-amine; 2-[2-(1-pyrrolidinyl)ethoxy]ethyl-N-(2-cyanoethyl)-amine; 2-[2-(1-pyrrolidinyl)ethoxy]propyl-N-methyl-N-(2-cyanoethyl-amine; 2-[2-(1-pyrrolidinyl)ethoxy]propyl-N-(2-cyanoethyl)-amine; 2-[21-pyrrolidinyl)propoxy]propyl-N-methyl-N-(2-cyanoethyl)-amine; 2-[2-(1-pyrrolidinyl)propoxy]propyl-N-(2-aminoethyl)-amine; 2-[2-(1-pyrrolidinyl)propoxy]ethyl-N-ethyl-N-(2-cyanoethyl)-amine; 2-[2-(1-pyrrolidinyl)propoxy]ethyl]-N-(2-aminoethyl)-amine; 2-[2-(1-piperidinyl)ethoxy]ethyl-N-methyl-N-(3-aminopropyl)-amine; 2-[2-(1-piperidinyl)ethoxy]ethyl-N-methyl-N-(2-aminoethyl)-amine; 2-[2-(1-piperidinyl)ethoxy]propyl-N-methyl-N-(3-aminopropyl)-amine; 2-[2-(1-piperidinyl)ethoxy]propyl-N-methyl-N-(2-aminoethyl)-amine; 2-[2-(1-piperidinyl)propoxy]propyl-N-methyl-N-(3-aminopropyl)-amine; 2-[2-(1-piperidinyl)propoxy]propyl-N-methyl-N-(2-aminoethyl)-amine; 2-[2-(1-piperidinyl)propoxy]ethyl-N-methyl-N-(3-aminopropyl)-amine; 2-[2-(1-piperidinyl)propoxy]ethyl-N-methyl-N-(2-aminoethyl)-amine; 2-[2-(1-piperidinyl)ethoxy]ethyl-N-methyl-N-(2-cyanoethyl)-amine; 2-[2-(1-piperidinyl)ethoxy]ethyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-(2-cyanoethyl)-amine; 2-[2-(1-piperidinyl)propoxy]propyl-N-methyl-N-(2-cyanoethyl)-amine; 2-[2-(1-piperidinyl)propoxy]propyl-N-(2-aminoethyl)-amine; 2-[2-(1-piperidinyl)propoxy]ethyl-N-methyl-N-(2-cyanoethyl)-amine; 2-[2-(1-piperidinyl)propoxy]ethyl]-N-(2-aminoethyl)-amine; or mixtures thereof.

The % ratio of inventive tertiary amine catalysts to other catalysts in the polyurethane application is about 100% to about 5%, about 80% to about 10% and in some cases about 70% to about 20%. These catalysts can be combined by any suitable method such as adding each separate catalyst to the premix or alternatively premixing both catalysts and adding the mixture of catalysts to the polyol premix.

In one embodiment of the invention, the inventive catalyst can be used in combination with at least one blowing amine catalyst selected from the group consisting of N,N,N′-trimethyl-N′-3-aminopropyl-bis(aminoethyl) ether, 2-[N-(dimethylaminoethoxyethyl)-N-methylamino]ethanol and N,N,N′-trimethyl-N′-(2-hydroxyethyl)-bis(aminoethyl) ether. The amount of blowing amine catalyst is about 0 pphp to about 5 pphp, about 0.01 pphp to about 2 pphp and in some cases about 0.05 pphp to about 1 pphp. These catalysts can be combined by any suitable method such as adding each separate catalyst to a polyol premix or alternatively premixing both catalysts and adding the mixture of catalysts to the polyol premix.

### Preparation of Foams

Foams of any of the various types known in the art may be made using the methods of this invention using typical polyurethane formulations. In one embodiment, the invention provides a method for making a polyurethane foam comprising reacting at least one isocyanate and at least one polyol in the presence of a catalyst composition comprising at least one tertiary amine with the formula:

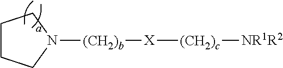

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or R═H and R²═—(CH₂)₂CN, or R¹ and R²═—(CH₂)₂CN.

For example, flexible polyurethane foams with the excellent characteristics described herein will comprise the components shown below in Table 1, in the amounts indicated. The components shown in Table 1 will be discussed in detail later below.

TABLE 1
Polyurethane Components

| Component | Parts by Weight |
|---|---|
| Base Polyol | 20-100 |
| Polymer polyol | 0-80 |
| Silicone surfactant | 0.5-10 |
| Blowing agent | 2-4.5 |
| Crosslinker | 0.5-2 |
| Catalyst | 0.25-10 |
| Carboxylic acid (optional) | 0.05-3.0 |
| Polyisocyanate | To provide NCO index = 60-115 |

The amount of polyisocyanate used in polyurethane formulations according to the invention is not limited, but it will be within those ranges known to those of skill in the art. An exemplary range is given in table I, indicated by reference to “NCO Index” (isocyanate index). As is known in the art, the NCO index is defined as the number of equivalents of isocyanate, divided by the total number of equivalents of active hydrogen, multiplied by 100. The NCO index is represented by the following formula.

NCO index=[NC0/(OH+NH)]*100

Flexible foams use copolymer polyols as part of the overall polyol content in the foam composition, along with base polyols of about 4000-5000 weight average molecular weight and hydroxyl number of about 28-35. Base polyols and copolymer polyols will be described in detail later herein.

Preferably, the polyols can have a functionality of about 2 to about 8. In another embodiment, the polyols can preferably have a functionality of about 2 to about 6. In a further embodiment, the polyols can preferably have a functionality of about 2 to about 4. Preferably, the polyols can also have a hydroxyl number from about 10 to about 900. In another embodiment, the polyols can preferably also have a hydroxyl number from about 15 to about 600. In a further embodiment, the polyols can preferably also have a hydroxyl number from about 20 to about 200.

### Catalysts

The catalyst composition of the present invention comprises at least one tertiary amine catalyst having the chemical structure

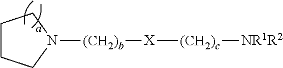

where a=1 or 2; b and c are independently 2 or 3; and X═O or N—CH₃; and R¹═R²═CH₃, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN which can be used as the sole catalyst or alternatively in combination with other tertiary amines having or not isocyante reactive groups. Isocyanate reactive groups present in the alternative tertiary amine gelling or blowing co-catalyst consist essentially of primary amine, secondary amine, primary-hydroxyl group, secondary-hydroxyl group, amide and urea. Preferred examples of such gelling co-catalysts comprise at least one member selected from the group consisting of N,N-bis(3-dimethylaminopropyl)-N-(2-hydroxypropyl) amine; N,N-dimethyl-N′,N′-bis(2-hydroxypropyl)-1,3-propylenediamine; dimethylaminopropylamine (DMAPA); N-methyl-N-2-hydroxypropyl-piperazine, bis-dimethylaminopropyl amine (POLYCAT® 15), dimethylaminopropyl urea and N,N′-bis(3-dimethylaminopropyl) urea (DABCOO NE1060, DABCOO NE1070, DABCO® NE1080 and DABCO® NE1082), 1,3-bis(dimethylamino)-2-propanol, 6-dimethylamino-1-hexanol, N-(3-aminopropyl)imidazole, N-(2-hydroxypropyl)imidazole, N,N′-bis(2-hydroxypropyl) piperazine, N-(2-hydroxypropyl)-morpholine, N-(2-hydroxyethylimidazole), N,N′-bis(2-hydroxypropyl) piperazine, N-(2-hydroxypropyl)-morpholine, N-(2-hydroxyethylimidazole), 2-hydroxymethyl-1,4-diazabicyclo[2.2.2]octane, N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; N,N-bis(3-dimethylaminopropyl)-N-[(2-hydroxypropyl)-3-aminopropyl]amine; N,N-bis(dimethylaminopropyl)-N-(3-aminopropyl)-amine; N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; and N,N-bis(3-dimethylaminopropyl)-N-[(2-hydroxypropyl)-3-aminopropyl]amine.

Preferably, the amount of the inventive catalyst can range from about 0.01 pphp to about 20 pphp, about 0.05 pphp to about 10 pphp, and in some cases about 0.1 pphp to about 5 pphp. Preferably, the amount of gelling co-catalyst can range from about 0 pphp to about 19 pphp, about 0 pphp to about 15 ppm, and in some cases about 0 pphp to about 10 pphp. Preferred examples of blowing co-catalysts containing isocyanate reactive groups that can be used in combination with the above mentioned catalysts include N,N,N′-trimethyl-N′-3-aminopropyl-bis(aminoethyl) ether, 2-[N-(dimethylaminoethoxyethyl)-N-methylamino]ethanol and N,N,N′-trimethyl-N′-(2-hydroxyethyl)-bis(aminoethyl) ether.

Preferably, the amount of blowing co-catalyst can range from about 0 pphp to about 5 pphp, about 0.01 pphp to about 2 pphp, and in some cases about 0.05 to about 1 pphp.

In one embodiment, the catalyst compositions may preferably also include other components, for example transition metal catalysts such as organotin compounds or bismuth carboxylates for example when the desired polyurethane foam is a flexible slab stock. Preferably, metal catalyst can also comprise at least one member selected from the group consisting of dialkyltin carboxylates such as dibutylin dilaureate, dimethyltin dilaureate, dimethyltin diacetate, dibutyltin diacetate, dimethyltin dilaurylmercaptide, dibutyltin dilaurylmercaptide, dimethyltin diisooctylmaleate, dibutyltin diisooctylmaleate, dimethyltin bis(2-ethylhexyl mercaptoacetate), dibutyltin bis(2-ethylhexyl mercaptoacetate), dimethyltinneodecanoate, dibutyltinneodecanoate, dimethyltinisononanoate, dibutyltinisononanoate, stannous octoate, stannous neodecanoate, stannous isononanoate or other suitable organotin catalysts or other suitable stannous carboxylate salts or a combination thereof. In one embodiment, other metals and salts thereof can preferably also be included, such as, for example, bismuth (Bi). Preferred metal salts include carboxylate salts including salts of acetic acid, propanoic acid, butanoic acid, pentanoic acid, neopentanoic acid, hexanoic acid, 2-ethylhexyl carboxylic acid, neohexanoic acid, octanoic acid, neooctanoic acid, heptanoic acid, neoheptanoic acid, nonanoic acid, neononanoic acid, decanoic acid, neodecanoic acid, undecanoic acid, neoundecanoic acid, dodecanoic acid, neododecanoic acid, myristic acid, pentadecanoic acid, hexadecanoic acid, heptadecanoic acid, octadecanoic acid and other suitable carboxylic acids. Other preferred salts of transition metals include lead (Pb), iron (Fe), zinc (Zn) with pentanoic acid, neopentanoic acid, hexanoic acid, 2-ethylhexyl carboxylic acid, octanoic acid, neooctanoic acid, neoheptanoic acid, neodecanoic acid, neoundecanoic acid, neododecanoic acid, and other suitable carboxylic acids may also be included. Preferably, the amount of the foregoing metal catalyst can range from about 0 pphp to about 20 pphp, about 0 pphp to about 10 pphp, and in some cases about 0 pphp to about 0.01 pphp.

In one embodiment, the inventive catalyst (and if desired co-gelling and blowing catalysts) can also be acid blocked with an acid including carboxylic acids (alkyl, substituted alkyl, alkylene, aromatic, substituted aromatic), sulfonic acids or any other organic or inorganic acid. Examples of carboxylic acids include mono-acids, di-acids or poly-acids with or without isocyanate reactive groups. Preferred examples of carboxylic acids include formic acid, acetic acid, propionic acid, butanoic acid, pentanoic acid, neopentanoic acid, hexanoic acid, 2-ethylhexyl carboxylic acid, neohexanoic acid, octanoic acid, neooctanoic acid, heptanoic acid, neoheptanoic acid, nonanoic acid, neononanoic acid, decanoic acid, neodecanoic acid, undecanoic acid, neoundecanoic acid, dodecanoic acid, neododecanoic acid, myristic acid, pentadecanoic acid, hexadecanoic acid, heptadecanoic acid, octadecanoic acid, benzoic acid, oxalic acid, malonic acid, succinic acid, glutaric acid, adipic acid, pimelic acid, suberic acid, azelaic acid, sebacic acid, glycolic acid, lactic acid, tartaric acid, citric acid, malic acid, salicylic acid and the like.

While the inventive amine catalyst of the invention can be used with amines listed above, such usage can increase emissions from foam during the foam's useful lifetime as well as during foam manufacturing because the thermal stability of the chemical bonds between the isocyanate reactive co-catalysts are not as stable as the inventive catalyst. Preferably, the total loading of the tertiary amine catalyst(s) (i.e., inventive plus any co-gelling catalysts) for making foam according to the invention will be in the range of about 0.1 to about 20 pphp, more preferably about 0.1 to about 10 pphp, and most preferably about 0.1 to about 5 pphp. However, any effective amount may be used. The term “pphp” means parts per hundred parts polyol.

In one aspect of the invention, the catalyst composition has a dimethylformamide (DMF) concentration between 0 ppm to 40 ppm.

### Organic Isocyanates

Organic isocyanate compounds preferably include, but are not limited to, hexamethylene diisocyanate (HDI), phenylene diisocyanate (PDI), toluene diisocyanate (TDI), and 4,4′-diphenylmethane diisocyanate (MDI). In one preferred aspect of the invention, 2,4-TDI, 2,6-TDI, or any mixture thereof is used to produce polyurethane foams. Other preferred isocyanate compounds are diisocyanate mixtures known commercially as “crude MDI.” One example is marketed by Dow Chemical Company under the name PAPI, and contains about 60% of 4,4′-diphenylmethane diisocyanate along with other isomeric and analogous higher polyisocyanates. While any suitable isocyanate can be used, an example of such isocyanate in one embodiment comprises isocyanate having an index range from about 60 to about 200. In another embodiment, the isocyanate has an index range from about 90 to about 120. Preferably, the amount of isocyanate ranges from about 95 to about 105. In another embodiment of the invention, the amount of isocyanate preferably ranges from about 60 to about 65.

### Polyol Component

Polyurethanes are produced by the reaction of organic isocyanates with the hydroxyl groups of polyol, and in some cases a mixture of polyols. The polyol component of the reaction mixture includes at least a main or “base” polyol. Base polyols for use in the invention preferably include, as non-limiting examples, polyether polyols. Polyether polyols preferably include poly(alkylene oxide) polymers such as poly(ethylene oxide) and poly(propylene oxide) polymers and copolymers with terminal hydroxyl groups derived from polyhydric compounds, including diols, triols and higher alcohols. Preferred examples of diols and triols for reaction with the ethylene oxide or propylene oxide include ethylene glycol, propylene glycol, 1,3-butanediol, 1,4-butanediol, 1,6-hexanediol, neopentyl glycol, diethylene glycol, dipropylene glycol, pentaerythritol, glycerol, diglycerol, trimethylol propane, and similar low molecular weight polyols. Other base polyol examples known in the art include polyhydroxy-terminated acetal resins, hydroxyl-terminated amines and hydroxyl-terminated polyamines. Examples of these and other suitable isocyanate-reactive materials may be found in U.S. Pat. No. 4,394,491; hereby incorporated by reference. Suitable polyether polyols also include those containing tertiary amine groups than can catalyze the gelling and the blowing reaction of polyurethanes, for example those described in U.S. Pat. No. 8,367,870; WO 03/016373 A1, WO 01/058976 A1; WO2004/060956 A1; WO03/016372 A1; and WO03/055930 A1; the disclosure of the foregoing US and WO publications is hereby incorporated by reference. Other useful polyols may include polyalkylene carbonate-based polyols and polyphosphate-based polyols.

In one aspect of the invention, a single high molecular weight polyether polyol may be used as the base polyol. Alternatively, a mixture of high molecular weight polyether polyols, for example, mixtures of di- and tri-functional materials and/or different molecular weight or different chemical composition materials may be used. Such di- and tri-functional materials include, but are not limited to polyethylene glycol, polypropylene glycol, glycerol-based polyether triols, trimethylolpropane-based polyether triols, and other similar compounds or mixtures.

In addition to the base polyols described above, or instead of them, materials commonly referred to as “copolymer polyols” may be included in a polyol component for use according to the invention. Copolymer polyols may be used in polyurethane foams to increase the resistance to deformation, for example to improve the load-bearing properties. Depending upon the load-bearing requirements, copolymer polyols may comprise from about 0 to about 80 percent by weight of the total polyol content.

Preferred examples of copolymer polyols include, but are not limited to, graft polyols and polyurea modified polyols, both of which are known in the art and are commercially available.

Graft polyols are prepared by copolymerizing vinyl monomers, preferably styrene and acrylonitrile, in a starting polyol. The starting polyol is preferably a glycerol-initiated triol, and is typically end-capped with ethylene oxide (approximately 80-85% primary hydroxyl groups). Some of the copolymer grafts to some of the starting polyol. The graft polyol also contains homopolymers of styrene and acrylonitrile and unaltered starting polyol. The styrene/acrylonitrile solids content of the graft polyol ranges from 5 wt % to 45 wt %, but any kind of graft polyol known in the art may be used.

Polyurea modified polyols are formed by the reaction of a diamine and a diisocyanate in the presence of a starting polyol, with the product containing polyurea dispersion. A preferred variant of polyurea modified polyols, also suitable for use, are polyisocyanate poly addition (PIPA) polyols, which are formed by the in situ reaction of an isocyanate and an alkanolamine in a polyol.

Preferably, other polyols that can be used according to the invention include natural oil polyols or polyols obtained from renewable natural resources such as vegetable oils. Polyols useful in the preparation of polyurethane foam from inexpensive and renewable resources are highly desirable to minimize the depletion of fossil fuel and other non-sustainable resources. Natural oils consist of triglycerides of saturated and unsaturated fatty acids. One natural oil polyol is castor oil, a natural triglyceride of ricinoleic acid which is commonly used to make polyurethane foam even though it has certain limitations such as low hydroxyl content. Other natural oils need to be chemically modified to introduce sufficient hydroxyl content to make them useful in the production of polyurethane polymers. There are two chemically reactive sites that can be considered when attempting to modify natural oil or fat into a useful polyol: 1) the unsaturated sites (double bonds); and 2) the ester functionality. Unsaturated sites present in oil or fat can be hydroxylated via epoxidation followed by ring opening or hydroformylation followed by hydrogenation.

Alternatively, trans-esterification can also be utilized to introduce OH groups in natural oil and fat. The chemical process for the preparation of natural polyols using epoxidation route involves a reaction mixture that requires epoxidized natural oil, a ring opening acid catalyst and a ring opener. Epoxidized natural oils include epoxidized plant-based oils (epoxidized vegetable oils) and epoxidized animal fats. The epoxidized natural oils may be fully or partially epoxidized and these oils include soybean oil, corn oil, sunflower oil, olive oil, canola oil, sesame oil, palm oil, rapeseed oil, tung oil, cotton seed oil, safflower oil, peanut oil, linseed oil and combinations thereof. Animal fats include fish, tallow and lard. These natural oils are triglycerides of fatty acids which may be saturated or unsaturated with various chain lengths from C₁₂ to C₂₄. These acids can be: 1) saturated: lauric, myristic, palmitic, steric, arachidic and lignoceric; 2) monounsaturated: palmitoleic, oleic, 3) poly-unsaturated: linoleic, linolenic, arachidonic. Partially or fully epoxidized natural oil may be prepared when reacting peroxyacid under suitable reaction conditions. Examples of peroxyacids utilized in the epoxidation of oils have been described in WO 2006/116456 A1; hereby incorporated by reference. Ring opening of the epoxidized oils with alcohols, water and other compounds having one or multiple nucleophilic groups can be used. Depending on the reaction conditions oligomerization of the epoxidized oil can also occur. Ring opening yields natural oil polyol that can be used for the manufacture of polyurethane products. In the hydroformylation/hydrogenation process, the oil is hydroformylated in a reactor filled with a hydrogen/carbon monoxide mixture in the presence of a suitable catalyst (preferably cobalt or rhodium) to form an aldehyde which is hydrogenated in the presence of cobalt or nickel catalyst to form a polyol. Alternatively, polyol from natural oil and fats can be produced by trans-esterification with a suitable poly-hydroxyl containing substance using an alkali metal or alkali earth metal base or salt as a trans-esterification catalyst. Any natural oil or alternatively any partially hydrogenated oil can be used in the transesterification process. Examples of oils include but are not limited to soybean, corn, cottonseed, peanut, castor, sunflower, canola, rapeseed, safflower, fish, seal, palm, tung, olive oil or any blend. Any multifunctional hydroxyl compound can also be used such as lactose, maltose, raffinose, sucrose, sorbitol, xylitol, erythritol, mannitol, or any combination.

Polyols amounts are defined by pphp. There are 3 types of polyols above defined: standard polyol or polyether polyol which can preferably be used in the range of about 100 pphp (the only polyol) to about 10 pphp. The copolymer polyol (CPP) can preferably be used in the range of about 0 to about 80 pphp. Finally the NOP (natural oil polyol) can preferably be present from about 0 to about 40 pphp.

In one embodiment, the polyols can preferably have an OH number from 10 to about 900 and a functionality from about 2 to 8. The polyol OH number and functionality are selected in order to obtain a foam having desired physical properties.

Open cell flexible molded foams preferably use a main or “base” polyether polyol. Polyether polyols include poly(alkylene oxide) polymers such as poly(ethylene oxide) and poly(propylene oxide) polymers and copolymers with terminal hydroxyl groups derived from polyhydric compounds, including diols and triols. Preferably, these polyols can have a functionality of about 2 to about 8. In another embodiment, these polyols can have a functionality of about 2 to about 6. In a further embodiment, these polyols can have a functionality of about 2 to about 4. Preferably, the polyols can also have a hydroxyl number from about 10 to about 900. In another embodiment, the polyols can have a functionality of about 15 to about 600. In a further embodiment, the polyols can have a functionality of about 20 to about 50. Flexible molded foams also use copolymer polyols as part of the overall polyol content in the foam composition with OH numbers preferably in the range of 15 to 50, MW ranges preferably from 1200 to 8000 and more preferably from 2000 to 6000, and % solids preferably from 10% to 60%. Open cell low density spray foam preferably use a polyether polyol with an average MW from 1500 to 6000 and OH number from 15 to 50. Polyols amounts are defined by pphp. There are 4 types of polyols above defined: standard polyol or polyether polyol which can be used in the range of about 100 pphp (the only polyol) to about 10 pphp. The copolymer polyol (CPP) can be used in the range of about 0 to about 80 pphp. The NOP (natural oil polyol) can be present from about 0 to about 40 pphp. Finally, the Mannich polyol is used in combination with other polyol and in a range from 0 pphp to 80 pphp, about 0 pphp to about 50 pphp and in some cases about 0 pphp to about 20 pphp.

In yet another aspect of the present invention, polyester polyols can be used, including those produced when a dicarboxylic acid is reacted with an excess of a diol. Non-limiting examples include adipic acid or phathalic acid or phthalic anhydride reacting with ethylene glycol or butanediol. Polyols useful in the present invention can be produced by reacting a lactone with an excess of a diol, for example, caprolactone reacted with propylene glycol. In a further aspect, active hydrogen-containing compounds such as polyester polyols and polyether polyols, and combinations thereof, are useful in the present invention.

### Blowing Agents

Polyurethane foam production may be aided by the inclusion of a blowing agent (BA) to produce voids in the polyurethane matrix during polymerization. Any suitable blowing agent may be used. Preferably, blowing agents include compounds with low boiling points which are vaporized during the exothermic polymerization reaction. Such blowing agents are generally inert or they have low reactivity and therefore it is likely that they will not decompose or react during the polymerization reaction. Preferred examples of low reactivity blowing agents include, but are not limited to, carbon dioxide, chlorofluorocarbons (CFCs), hydrofluorocarbons (HFCs), hydrochlorofluorocarbons (HCFCs), fluoroolefins (FOs), chlorofluoroolefins (CFOs), hydrofluoroolefins (HFOs), hydrochlorfluoroolefins (HCFOs), acetone, and low-boiling hydrocarbons such as cyclopentane, isopentane, n-pentane, and their mixtures. The amount of BA is preferably from about 0 (for example when water is used to blow the polyurethane polymer) to about 80 pphp. Other preferred blowing agents include compounds, for example water, that react with isocyanate compounds to produce a gas. Water (which reacts with isocyanate making CO₂) can be present in the range from about 0 (if a BA is included) to about 60 pphp (a very low density foam), from about 1.0 pphp to about 10 pphp and, in some cases, from about 2.0 pphp to about 5 pphp.

### Other Optional Components

A variety of other ingredients may be included in the formulations for making foams according to the invention. Preferred examples of optional components include, but are not limited to, cell stabilizers, crosslinking agents, chain extenders, pigments, fillers, flame retardants, auxiliary urethane gelling catalysts, auxiliary urethane blowing catalysts, transition metal catalysts, alkali and alkali earth carboxylate salts and combinations of any of these.

Preferred cell stabilizers may include, for example, silicone surfactants as well as organic anionic, cationic, zwitterionic or nonionic surfactants. Preferred examples of silicone surfactants include, but are not limited to, polyalkylsiloxanes, polyoxyalkylene polyol modified dimethylpolysiloxanes, alkylene glycol-modified dimethylpolysiloxanes, or any combination thereof. Preferred anionic surfactants include, but are not limited to, salts of fatty acids, salts of sulfuric acid esters, salts of phosphoric acid esters, salts of sulfonic acids, and combinations of any of these. Preferred cationic surfactants include, but are not limited to quaternary ammonium salts (pH dependent or permanently charged) such as cetyl trimethylammonium chloride, cetyl pyridinium chloride, polyethoxylated tallow amine, benzalkonium chloride, benzethonium chloride and the like. Preferred zwitterionic or amphoteric surfactants include but are not limited to sultaines, aminoacids, imino acids, betaines and phosphates. Preferred non-ionic surfactants include but are not limited to fatty alcohols, polyoxyethylene glycol alkyl ethers, polyoxypropylene glycol alkyl ethers, glucosides (such as decyl, lauryl and octyl glucosides), polyoxyethylene glycol alkyl phenol ethers, glycol alkyl esters, and the like. Preferably, cell stabilizers can be used in an amount from about 0.1 to about 20 pphp, from about 0.1 to about 10 pphp and, in some cases, from about 0.1 to about 5.0 pphp. Preferably, fire retardants can be used in an amount from about 0 to about 20 pphp and from about 0 to about 10 pphp and from about 0 to about 5 pphp.

Preferred crosslinking agents include, but are not limited to, low-molecular weight compounds containing at least two moieties selected from hydroxyl groups, primary amino groups, secondary amino groups, and other active hydrogen-containing groups which are reactive with an isocyanate group. Preferred crosslinking agents include, for example, polyhydric alcohols (especially trihydric alcohols, such as glycerol and trimethylolpropane), polyamines, and combinations thereof. Non-limiting examples of preferred polyamine crosslinking agents include diethyltoluenediamine, chlorodiaminobenzene, diethanolamine, diisopropanolamine, triethanolamine, tripropanolamine, 1,6-hexanediamine, and combinations thereof. Typical diamine crosslinking agents comprise twelve carbon atoms or fewer, more commonly seven or fewer. Preferably, crosslinking agents can be used in an amount from about 0.1 to about 20 pphp, from about 0.1 to about 10 pphp and, in some cases, from about 0.1 to about 5.0 pphp.

Preferred examples of chain extenders include, but are not limited to, compounds having hydroxyl or amino functional group, such as glycols, amines, diols, and water. Specific non-limiting examples of preferred chain extenders include ethylene glycol, diethylene glycol, propylene glycol, dipropylene glycol, 1,4-butanediol, 1,3-butanediol, 1,5-pentanediol, neopentyl glycol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, or any mixture thereof. Preferably, chain extenders can be used in an amount from about 0.1 to about 100 pphp, from about 0.1 to about 50 pphp and, in some cases, from about 0.1 to about 5.0 pphp.

Pigments may be used to color code the polyurethane foams during manufacture, for example to identify product grade or to conceal yellowing. Pigments may include any suitable organic or inorganic pigments known in the polyurethane art. For example, organic pigments or colorants include, but are not limited to, azo/diazo dyes, phthalocyanines, dioxazines, and carbon black. Preferred examples of inorganic pigments include, but are not limited to, titanium dioxide, iron oxides, or chromium oxide. The amount of pigment can range from about 0 pphp (no pigments added) to about 40 pphp.

Fillers may be used to increase the density and load bearing properties of polyurethane foams. Preferred fillers include, but are not limited to, barium sulfate or calcium carbonate. Preferably, the amount of fillers can range from about 0 pphp (no fillers added) to about 40 pphp.

Flame retardants may be used to reduce the flammability of polyurethane foams. Preferred flame retardants include, but are not limited to, chlorinated phosphate esters, chlorinated paraffins, or melamine powders. Preferably, flame retardants can be used in an amount from about 0 to about 20 pphp and from about 0 to about 10 pphp and from about 0 to about 5 pphp.

In one aspect of the invention, the inventive catalyst can preferably be used with amine catalysts having no isocyanate groups known as fugitive catalysts. A preferred list of examples of fugitive amine catalysts within this category include triethylenediamine (TEDA), N-methylimidazole, 1,2-dimethyl-imidazole, N-methylmorpholine, N-ethylmorpholine, triethylamine, N,N′-dimethyl-piperazine, 1,3,5-tris(dimethylaminopropyl)hexahydrotriazine, 2,4,6-tris(dimethylamino-methyl)phenol, N-methyldicyclohexylamine, pentamethyldipropylene triamine, N-methyl-N-(2-dimethylamino)-ethyl-piperazine, tributylamine, pentamethyldiethylenetriamine, hexamethyltriethylenetetramine, heptamethyltetraethylenepentamine, dimethylamino-cyclohexylamine, bis(dimethylaminoethyl)ether, tris(3-dimethylamino)propylamine, 1,8-diazabicyclo[5.4.0]undecene, or its acid blocked derivatives, and the like, as well as any mixture thereof.

Certain aspects of the invention are illustrated by the following Examples. These Examples are illustrative only and shall not limit the scope of any claims appended hereto. Foams were evaluated by using Handmix Evaluations or Machine Evaluations as described below.

The following invention is directed to the following aspects:

<1> A catalyst composition comprising at least one tertiary amine with the formula:

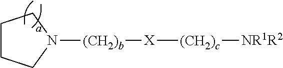

where a=1 or 2; b and c are independently 2 or 3; and X═O or N—CH₃; and R¹═R²═CH₃, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.
<2> The catalyst composition of aspect <1> wherein the at least one tertiary amine is selected from the group consisting of 2-[2-(1-pyrrolidinyl)ethoxy]ethyl-N,N-dimethyl amine; 2-[2-(1-pyrrolidinyl)ethoxy]ethyl-N-methyl-N-ethyl-amine; 2-[2-(1-pyrrolidinyl)ethoxy]ethyl-N-methyl-N-propyl-amine; 2-[2-(1-pyrrolidinyl)ethoxy]ethyl-N-methyl-N-isopropyl-amine; 2-[2-(1-pyrrolidinyl)ethoxy]ethyl-N-methyl-N-(n-butyl)-amine; 2-[2-(1-pyrrolidinyl)ethoxy]ethyl-N-methyl-N-(sec-butyl)-amine; 2-[2-(1-pyrrolidinyl)ethoxy]ethyl-N-methyl-N-(iso-butyl)-amine; 2-[2-(1-pyrrolidinyl)ethoxy]propyl-N,N-dimethyl amine; 2-[2-(1-pyrrolidinyl)ethoxy]propyl-N-methyl-N-ethyl-amine; 2-[2-(1-pyrrolidinyl)ethoxy]propyl-N-methyl-N-propyl-amine; 2-[2-(1-pyrrolidinyl)ethoxy]propyl-N-methyl-N-isopropyl-amine; 2-[2-(1-pyrrolidinyl)ethoxy]propyl-N-methyl-N-(n-butyl)-amine; 2-[2-(1-pyrrolidinyl)ethoxy]propyl-N-methyl-N-(sec-butyl)-amine; 2-[2-(1-pyrrolidinyl)ethoxy]propyl-N-methyl-N-(iso-butyl)-amine; 2-[2-(1-pyrrolidinyl)propoxy]ethyl-N,N-dimethyl amine; 2-[2-(1-pyrrolidinyl)propoxy]ethyl-N-methyl-N-ethyl-amine; 2-[2-(1-pyrrolidinyl)propoxy]ethyl-N-methyl-N-propyl-amine; 2-[2-(1-pyrrolidinyl)propoxy]ethyl-N-methyl-N-isopropyl-amine; 2-[2-(1-pyrrolidinyl)propoxy]ethyl-N-methyl-N-(n-butyl)-amine; 2-[2-(1-pyrrolidinyl)propoxy]ethyl-N-methyl-N-(sec-butyl)-amine; 2-[2-(1-pyrrolidinyl)propoxy]ethyl-N-methyl-N-(iso-butyl)-amine; 2-[2-(1-pyrrolidinyl)propoxy]propyl-N,N-dimethyl amine; 2-[2-(1-pyrrolidinyl)propoxy]propyl-N-methyl-N-ethyl-amine; 2-[2-(1-pyrrolidinyl)propoxy]propyl-N-methyl-N-propyl-amine; 2-[2-(1-pyrrolidinyl)propoxy]propyl-N-methyl-N-isopropyl-amine; 2-[2-(1-pyrrolidinyl)propoxy]propyl-N-methyl-N-(n-butyl)-amine; 2-[2-(1-pyrrolidinyl)propoxy]propyl-N-methyl-N-(sec-butyl)-amine; 2-[2-(1-pyrrolidinyl)propoxy]propyl-N-methyl-N-(iso-butyl)-amine; 2-[2-(1-pyrrolidinyl)ethoxy]ethyl-N-methyl-N-(2-cyanoethyl)-amine; 2-[2-(1-pyrrolidinyl)ethoxy]ethyl-N-methyl-N-(3-aminopropyl)-amine; 2-[2-(1-pyrrolidinyl)ethoxy]ethyl-N-methyl-N-(2-aminoethyl)-amine; 2-[2-(1-pyrrolidinyl)ethoxy]propyl-N-methyl-N-(2-cyanoethyl)-amine; 2-[2-(1-pyrrolidinyl)ethoxy]propyl-N-methyl-N-(3-aminopropyl)-amine; 2-[2-(1-pyrrolidinyl)ethoxy]propyl-N-methyl-N-(2-aminoethyl)-amine; 2-[2-(1-pyrrolidinyl)propoxy]propyl-N-methyl-N-(3-aminopropyl)-amine; 2-[2-(1-pyrrolidinyl)propoxy]propyl-N-methyl-N-(2-aminoethyl)-amine; 2-[2-(1-pyrrolidinyl)propoxy]ethyl-N-methyl-N-(3-aminopropyl)-amine; 2-[2-(1-pyrrolidinyl)propoxy]ethyl-N-methyl-N-(2-aminoethyl)-amine; 2-[2-(1-pyrrolidinyl)ethoxy]ethyl-N-methyl-N-(2-cyanoethyl)-amine; 2-[2-(1-pyrrolidinyl)ethoxy]ethyl-N-(2-cyanoethyl)-amine; 2-[2-(1-pyrrolidinyl)ethoxy]propyl-N-methyl-N-(2-cyanoethyl)-amine; 2-[2-(1-pyrrolidinyl)ethoxy]propyl-N-(2-cyanoethyl)-amine; 2-[2-(1-pyrrolidinyl)propoxy]propyl-N-methyl-N-(2-cyanoethyl)-amine; 2-[2-(1-pyrrolidinyl)propoxy]propyl-N-(2-aminoethyl)-amine; 2-[2-(1-pyrrolidinyl)propoxy]ethyl-N-methyl-N-(2-cyanoethyl)-amine; 2-[2-(1-pyrrolidinyl)propoxy]ethyl]-N-(2-aminoethyl)-amine, 2-[2-(1-piperidinyl)ethoxy]ethyl-N,N-dimethyl amine; 2-[2-(1-piperidinyl)ethoxy]ethyl-N-methyl-N-ethyl-amine; 2-[2-(1-piperidinyl)ethoxy]ethyl-N-methyl-N-propyl-amine; 2-[2-(1-piperidinyl)ethoxy]ethyl-N-methyl-N-isopropyl-amine; 2-[2-(1-piperidinyl)ethoxy]ethyl-N-methyl-N-(n-butyl)-amine; 2-[2-(1-piperidinyl)ethoxy]ethyl-N-methyl-N-(sec-butyl)-amine; 2-[2-(1-piperidinyl)ethoxy]ethyl-N-methyl-N-(iso-butyl)-amine; 2-[2-(1-piperidinyl)ethoxy]propyl-N,N-dimethyl amine; 2-[2-(1-piperidinyl)ethoxy]propyl-N-methyl-N-ethyl-amine; 2-[2-(1-piperidinyl)ethoxy]propyl-N-methyl-N-propyl-amine; 2-[2-(1-piperidinyl)ethoxy]propyl-N-methyl-N-isopropyl-amine; 2-[2-(1-piperidinyl)ethoxy]propyl-N-methyl-N-(n-butyl)-amine; 2-[2-(1-piperidinyl)ethoxy]propyl-N-methyl-N-(sec-butyl)-amine; 2-[2-(1-piperidinyl)ethoxy]propyl-N-methyl-N-(iso-butyl)-amine; 2-[2-(1-piperidinyl)propoxy]ethyl-N,N-dimethyl amine; 2-[2-(1-piperidinyl)propoxy]ethyl-N-methyl-N-ethyl-amine; 2-[2-(1-piperidinyl)propoxy]ethyl-N-methyl-N-propyl-amine; 2-[2-(1-piperidinyl)propoxy]ethyl-N-methyl-N-isopropyl-amine; 2-[2-(1-piperidinyl)propoxy]ethyl-N-methyl-N-(n-butyl)-amine; 2-[2-(1-piperidinyl)propoxy]ethyl-N-methyl-N-(sec-butyl)-amine; 2-[2-(1-piperidinyl)propoxy]ethyl-N-methyl-N-(iso-butyl)-amine; 2-[2-(1-piperidinyl)propoxy]propyl-N,N-dimethyl amine; 2-[2-(1-piperidinyl)propoxy]propyl-N-methyl-N-ethyl-amine; 2-[2-(1-piperidinyl)propoxy]propyl-N-methyl-N-propyl-amine; 2-[2-(1-piperidinyl)propoxy]propyl-N-methyl-N-isopropyl-amine; 2-[2-(1-piperidinyl)propoxy]propyl-N-methyl-N-(n-butyl)-amine; 2-[2-(1-piperidinyl)propoxy]propyl-N-methyl-N-(sec-butyl)-amine; 2-[2-(1-piperidinyl)propoxy]propyl-N-methyl-N-(iso-butyl)-amine; 2-[2-(1-piperidinyl)ethoxy]ethyl-N-methyl-N-(3-aminopropyl)-amine; 2-[2-(1-piperidinyl)ethoxy]ethyl-N-methyl-N-(2-aminoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(3-aminopropyl)-amine; 2-[2-(1-piperidinyl)ethoxy]propyl-N-methyl-N-(2-aminoethyl)-amine; 2-[2-(1-piperidinyl)propoxy]propyl-N-methyl-N-(3-aminopropyl)-amine; 2-[2-(1-piperidinyl)propoxy]propyl-N-methyl-N-(2-aminoethyl)-amine; 2-[2-(1-piperidinyl)propoxy]ethyl-N-methyl-N-(3-aminopropyl)-amine; 2-[2-(1-piperidinyl)propoxy]ethyl-N-methyl-N-(2-aminoethyl)-amine; 2-[2-(1-piperidinyl)ethoxy]ethyl-N-methyl-N-(2-cyanoethyl)-amine; 2-[2-(1-piperidinyl)ethoxy]ethyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-(2-cyanoethyl)-amine; 2-[2-(1-piperidinyl)propoxy]propyl-N-methyl-N-(2-cyanoethyl)-amine; 2-[2-(1-piperidinyl)propoxy]propyl-N-(2-aminoethyl)-amine; 2-[2-(1-piperidinyl)propoxy]ethyl-N-methyl-N-(2-cyanoethyl)-amine; and 2-[2-(1-piperidinyl)propoxy]ethyl]-N-(2-aminoethyl)-amine.
<3> The catalyst composition of aspect <1> or <2> further comprising a gelling co-catalyst selected from the group consisting of N,N-bis(3-dimethylaminopropyl)-N-(2-hydroxypropyl) amine; N,N-dimethyl-N′,N′-bis(2-hydroxypropyl)-1,3-propylenediamine; dimethylaminopropylamine (DMAPA); N-methyl-N-2-hydroxypropylpiperazine, bis-dimethylaminopropyl amine (POLYCAT® 15), dimethylaminopropyl urea and N,N′-bis(3-dimethylaminopropyl) urea (DABCO® NE060, DABCO® NE1070, DABCO® NE1080 and DABCO® NE1082), 1,3-bis(dimethylamino)-2-propanol, 6-dimethylamino-1-hexanol, N-(3-aminopropyl)imidazole, N-(2-hydroxypropyl)imidazole, N,N′-bis(2-hydroxypropyl) piperazine, N-(2-hydroxypropyl)-morpholine, N-(2-hydroxyethylimidazole), N,N′-bis(2-hydroxypropyl) piperazine, N-(2-hydroxypropyl)-morpholine, N-(2-hydroxyethylimidazole), 2-hydroxymethyl-1,4-diazabicyclo[2.2.2]octane, N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; N,N-bis(3-dimethylaminopropyl)-N-[(2-hydroxypropyl)-3-aminopropyl]amine; N,N-bis(dimethylaminopropyl)-N-(3-aminopropyl)-amine; N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; and N,N-bis(3-dimethylaminopropyl)-N-[(2-hydroxypropyl)-3-aminopropyl]amine.
<4> The catalyst composition of any of aspects <1> to <3> further comprising a blowing co-catalyst selected from the group consisting of N,N,N′-trimethyl-N′-3-aminopropyl-bis(aminoethyl) ether, 2-[N-(dimethylaminoethoxyethyl)-N-methylamino]ethanol and N,N,N′-trimethyl-N′-(2-hydroxyethyl)-bis(aminoethyl) ether.
<5> The catalyst composition of any of aspects <1> to <4> wherein the catalyst composition has a dimethylformamide concentration between 0 ppm to 40 ppm.
<6> A method for the manufacturing of a catalyst composition comprising at least one tertiary amine with the formula:

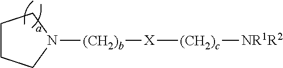

where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.
<7> The method of aspect <6> wherein X═O and the method comprises converting cyclic-amines to cycloamino-alkylether amines by the following reaction sequence: a) alkoxylation of a cyclic-amine to give cycloamine-alkoxyalcohol; and b) conversion of the cycloamine-alkoxyalcohol to the cycloamine-alkoxy-alkylamine.
<8> The method of aspect <6> wherein X═N—CH₃ and the method comprises converting cyclic amines to cycloamino-alkylether-amine-nitriles and to cycloamino-alkylether-amines having a primary or secondary amine functionality by the following reaction sequence: a) alkoxylation of a cyclic-amine to give cycloamine-alkoxyalcohol; b) conversion of the cycloamine-alkoxyalcohol to the cycloamine-alkoxy-alkylamine; c) conversion of the cycloamine-alkoxy-alkylamine to cycloamino-alkylether-amine-nitriles; d) conversion of the cycloamino-alkyl-ether-amine-nitriles to cycloamino-alkyl-ether amine having a primary amine functionality.
<9> A method for making a polyurethane foam comprising reacting at least one isocyanate and at least one polyol in the presence of the catalyst composition of any of aspects <1> to <5>.
<10> The method of aspect <9> further comprising reacting at least one gelling co-catalyst.
<11> The method of aspect <9> or <10> further comprising reacting a blowing co-catalyst.
<12> A polyurethane foam formulation comprising at least one polyol component, at least one isocyanate component, and the catalyst composition of any of aspects <1> to <5>.

### EXAMPLES

### Example 1: Inventive

### Vapor Phase Amination of 2-[2-(dimethylamino)ethoxy]ethanol with Pyrrolidine to Produce 2-[2-(1-pyrrolidinyl)ethoxy]ethyl-N,N-dimethylamine in a Continuous Fixed Bed Reactor

A fixed bed tubular reactor, equipped with a 10 cc quartz preheatbed, was charged with 9.2 g of the CuO/ZnO/Al₂O₃ catalyst as described in the prior art. The reactor was pressurized with nitrogen to 300 psig, and then vented to ambient. The reactor pressure was maintained by means of a backpressure controller. The nitrogen purge was repeated two additional cycles, followed by three hydrogen purges. The reactor was then fed hydrogen at 500 scc/m and 300 psig. The reactor was heated at 1° C. per minute with a resistance heater to 250° C. and held at that temperature for 4 hr to activate the catalyst. The hydrogen flow, metered via a mass flow controller, was adjusted to provide a 4/1 molar ratio of Hydrogen/DMAEE (DMAEE is 2-[2-(dimethylamino)ethoxy]ethanol). DMAEE was fed to the reactor under pressure, via a constant flow syringe pump. Pyrrolidine was co-fed to the reactor under pressure, via a constant flow syringe pump at pyrrolidine/DMAEE molar ratio of 2/1. Effluent from the reactor was analyzed by gas chromatography (GC). After several GC samples, the composition of the mixture remains unchanged over time. Recovered product showed no sign of a blue-green tint, indicating that copper leaching had not occurred to any appreciable extent. Analysis of the effluent by GC and GCMS confirms the formation of 2-[2-(1-pyrrolidinyl)ethoxy]ethy-N,N-direthylamine (PyEEDMA). PyEEDMA yield selectivity was 65-70%. PyEEDMA conversion was 60% with the main remaining products unconverted raw materials (pyrrolidine and DMAEE). These results indicate that BDMAEE can be produced at good yield in a vapor phase amination of DMAEE with pyrrolidine in a continuous fixed bed reactor.

### Example 2: Comparative

### Conventional Ethoxylation of Pyrrolidine to 2-[2-(1-pyrrolidinyl)ethoxy]ethanol (PyEE) with Ethylene Oxide

In a 1000 ml laboratory autoclave equipped with a stirring device, a heatable jacket, pressure pickup and temperature probe and inert gas feed line, an amount of 333.4 ml of a 3 molar solution of ethylene oxide in THF was cooled by means of a dry ice/IPA cooling mixture. Ethylene oxide (44 g, 1.0 mol) and a further 35.56 g (0.5 mol) of pyrrolidine was added. The autoclave which had previously been flushed with nitrogen was then heated to 100° C. by means of a thermal oil via the jacket, it being possible to observe a pressure rise. The reaction temperature was then maintained for 6 hours with stirring. After the reaction time had ended, the mixture was allowed to cool to room temperature, and the pressure vessel was depressurized and flushed with nitrogen. The solvent was removed on a rotary evaporator at a bath temperature of 50° C. in a membrane pump vacuum for several hours. The back-colored crude reaction mixture was then analyzed by gas chromatography showing 15.1% of unreacted pyrrolidine, 42.9% of monoethoxylated pyrrolidine, 26.7% of the diethoxylated pyrrolidine, 10.7% of tri-ethoxylated pyrrolidine and a total of 4.6% of further by-products were also found.

### Example 3: Inventive

### Prophetic: Sequential Catalytic Ethoxylation of Pyrrolidine to 2-[2-(1-pyrrolidinyl)ethoxy]ethanol (PyEE) with Ethylene Oxide in the Absence Followed by in the Presence of Alkoxylation Catalysts

In a 1000 ml laboratory autoclave equipped with a stirring device, a heatable jacket, pressure pickup and temperature probe and inert gas feed line, an amount of pyrrolidine (35.56 g, 0.5 mol) is added. The autoclave is purged with nitrogen at least three times. Ethylene oxide (22.0 g, 0.5 mol) is then supplied to the reactor on an equivalent molar basis (166.7 ml of a 3 molar solution of ethylene oxide in THF is cooled by means of a dry ice/IPA cooling mixture). The EO solution in THF is added to the reactor semi-batch at room temperature and exotherm is monitored with a temperature controller. The temperature in the reactor is slowly increased until it reaches about 100° C. The reaction temperature is then maintained for 1 hour with stirring until all the EO is consumed. After the reaction time ends, the mixture is allowed to cool to room temperature. A solution of ethoxylation catalyst (30% sodium methylate in methanol, 9.0 g of solution, 0.05 mol NaOCH₃) is added to the reactor. Ethylene oxide (22.0 g, 0.5 mol) is then supplied to the reactor on an equivalent molar basis (166.7 ml of a 3 molar solution of ethylene oxide in THF is cooled by means of a dry ice/IPA cooling mixture). The EO solution in THF is added to the reactor semi-batch at room temperature and exotherm is monitored with a temperature controller. The temperature is slowly increased to about 100° C. until the reaction is complete. The product is analyzed by GC and GCMS. The sequential EO addition in the absence/presence of catalyst shows improved yields for the di-ethoxylated product as well a better color and minimization of quaternary decomposition products. The desired product 2-[2-(1-pyrrolidinyl)ethoxy]ethanol is purified by fractional distillation.

### Example 4: Inventive

### Vapor Phase Amination of 2-[2-(1-pyrrolidinyl)ethoxy]ethanol (PyEE) with Monomethyl Amine (MMA) to Give 2-[2-(1-pyrrolidinyl)ethoxy]ethyl]-N-methylamine (PyEEMA) in a Continuous Fixed Bed Reactor

A fixed bed tubular reactor, equipped with a 10 cc quartz preheatbed, was charged with 9.2 g of the CuO/ZnO/A₂O₃ catalyst as described in the prior art. The reactor was pressurized with nitrogen to 300 psig, and then vented to ambient. The reactor pressure was maintained by means of a backpressure controller. The nitrogen purge was repeated two additional cycles, followed by three hydrogen purges. The reactor was then fed hydrogen at 500 scc/m and 300 psig. The reactor was heated at 1° C. per minute with a resistance heater to 250° C. and held at that temperature for 4 hr to activate the catalyst. The hydrogen flow, metered via a mass flow controller, was adjusted to provide a 4/1 molar ratio of Hydrogen/PyEE (PyEE is 2-[2-(1-pyrrolidinyl)ethoxy]ethanol). The reactor was then conditioned to about 220° C. and PyEE was fed to the reactor under pressure, via a constant flow syringe pump. MMA was co-fed to the reactor under hydrogen pressure (25 psig), via a constant flow syringe pump at MMA/PyEE molar ratio of 3.5/1. Effluent from the reactor was analyzed by gas chromatography (GC). After several GC samples, the composition of the mixture remains unchanged over time. Recovered product showed no sign of a blue-green tint, indicating that copper leaching had not occurred to any appreciable extent. Analysis of the effluent by GC and GCMS confirms the formation of 2-[2-(1-pyrrolidinyl)ethoxy]ethyl-N-methyl-amine (PyEEMA). PyEEMA yield selectivity was 65%. PyEEMA conversion was 60% with the main remaining byproducts being 2-[2-(1-pyrrolidinyl)ethoxy]ethyl-N,N dimethylamine (PyEEDMA) and bis(2-pyrrolidinylethyl)ether with the latter being removed by distillation. These results indicate that PyEEMA can be produced at good yield in a vapor phase amination of PyEE with MMA in a continuous fixed bed reactor.

### Example 5: Inventive

### Cyanoethylation of 2-[2-(1-pyrrolidinyl)ethoxy]ethyl]-N-methylamine (PyEEMA) with Acrylonitrile to Give 2-[2-(1-pyrrolidinyl)ethoxy]ethyl-A-methy-N-(2-cyanoethyl)-amine (PyEECEMA)

Into a three necked round bottom flask equipped with a teflon coated magnetic stir bar, reflux condenser, pressure equalizing dropping funnel, and thermometer was placed 86 g, 0.5 mol of the distilled product from Example 4 (2-[2-(1-pyrrolidinyl)ethoxy]ethyl]-N-methylamine (PyEEMA)). The mixture was heated to 55° C. and 28 g (0.53 moles) of acrylonitrile was added over a period of two hours. The reaction was allowed to proceed an additional five hours until less than 1% of unreacted PyEEMA remained. The crude product was used without any further purification.

### Example 6; Inventive

### Hydrogenation of 2-[2-(1-pyrrolidinyl)ethoxy]ethyl-N-methyl-N-(2-cyanoethyl)-amine (PyEECEMA) to Give 2-[2-(1-pyrrolidinyl)ethoxy]ethyl-N-methyl-N-(3-aminopropyl)-amine (PyEEAPMA)

Into a 1 liter stainless steel autoclave was placed 20 g of Raney Cobalt catalyst and 200 g of isopropanol. The reaction vessel was sealed and purged with nitrogen then hydrogen. The contents of the reaction vessel were then heated to 120° C. and the pressure adjusted to 650 psi with hydrogen. Then 115 g of the product from example 5 was pumped into the reaction vessel over a period of 3.5 hours at 650 psig hydrogen pressure and 1000 rpm mechanical stirring. The reaction was allowed to proceed an additional 50 minutes during which time less than 1% of the total hydrogen used was consumed. The hydrogen pressure was maintained at 650 psig throughout the reaction by admission of hydrogen from a 3.79 liter ballast on demand from a dome regulator. The reaction vessel was then cooled and vented and the contents filtered through a 0.5 micron fritted stainless steel filter. The crude product was placed into a one liter flask and distilled through a packed column to afford 97.5% pure product corresponding to 2-[2-(1-pyrrolidinyl)ethoxy]ethyl-N-methyl-N-(3-aminopropyl)-amine (PyEEAPMA).

### Example 7: Inventive

### Flexible TDI Based Polyurethane Foam Evaluations: Rate of Rise Kinetics and Use Level Comparison for Catalysts Made in EXAMPLE 1(PyEEDMA) and EXAMPLE 6 (PyEEAPMA)

Foaming performance can be evaluated by comparing the foam height versus time for standards and new amine catalyst. Foam height profile can be measured by automated rate of rise equipment, utilizing free-rise cup foam samples with a FOMAT sonar rate-of-rise device (hereafter referred to as a “ROR”). The FOMAT device comprises a sonar sensor that measures and records the height in millimeters (mm) of the rising foam sample versus time in seconds (s), directly after mixing all components of the formulation. The FOMAT standard software generates both height versus time plots and velocity versus time plots. These plots are useful for comparing the relative reactivity of different catalyst formulations. Flexible foam can be prepared by combining a total weight of about 300 g of the ingredients in Table 2 other than the isocyanate in a 32-oz (951 ml) paper cup. This premix formulation is then mixed for about 10 seconds at about 6,000 rpm using an overhead stirrer fitted with a 2-inch (5.1 cm) diameter stirring paddle. Sufficient toluene diisocyanate is then added to achieve the desired Isocyanate Index of about 100, and the formulation is mixed well for about another 6 seconds at about 6,000 rpm using the same stirrer. The cup is then placed under the FOMAT sensor. The start time for ROR measurement is automated for the FOMAT and begins directly after the end of the final mixing. Once the cup is placed under the ROR, the chemical mixture begins to polymerize. Since the walls of the cup restrict the expansion in all but the vertical direction, this expansion manifests itself in this experiment as an increase in height with passing time.

TABLE 2
TDI-Based Premix Components

| Component | PPHP |
|---|---|
| SPECFLEX ® NC 630¹ Polyol | 50 |
| SPECFLEX ® NC 700² Polyol | 50 |
| Water | 3.0 |
| DABCO ® DC6070³ (Low emissions silicon | 0.60 |
| surfactant) | |
| Catalyst⁴ | Varied |
| Diethanolamine (crosslinker) | 0.70 |
| Toluene diisocyanate | To provide NCO |
| | index = 100 |

¹High functionality capped polyether polyol of high molecular weight, functionality, and primary hydroxyl content with a base polyol molecular weight of about 5500, available from Dow Chemical Company, Midland, MI.
²Grafted polyether polyol containing copolymerized styrene and acrylonitrile, base polyol molecular weight about 4800, available from Dow Chemical Company, Midland, MI.
³Silicone surfactant is available from Air Products and Chemicals, Inc.
⁴The amine catalyst is available from Evonik Corporation.

This increase in height can also be displayed as a rate of changing height (velocity) versus time. Useful comparisons can be made on the rate of the foaming reaction by recording the time required after mixing for the foam to reach a standard height (TOC=Top of the Cup), the maximum foam rise velocity, the time after mixing that was required to achieve the maximum velocity as well as the string gel time (SGT) which is the time at which the polymerizing mass is able to form polymer strings when touched with a wooden tongue suppressor.

TABLE 3
Foam Top of the Cup and String Gel Time in Seconds

| | | Gel | | Gel | | |
|---|---|---|---|---|---|---|
| Run | | Cat | | Cat | | SG |
| # | Gel Catalyst | pphp | Blow Catalyst | pphp | TOC | (sec) |
| 1 | DABCO ®33LV | 0.30 | DABCO ®BL11 | 0.10 | 36 | 58 |
| 2 | DABCO ®33LV | 0.30 | EXAMPLE 1 | 0.10 | 34 | 58 |
| | | | (PyEEDMA) | | | |
| 3 | DABCO ®NE1550 | 0.35 | DABCO ®NE300 | 0.17 | 42 | 61 |
| 4 | DABCO ®NE1550 | 0.35 | EXAMPLE 6 | 0.19 | 38 | 61 |
| | | | (PyEEAPMA) | | | |

DABCO ®33LV is a 33% solution of triethylenediamine in dipropylene glycol commercially available from Evonik Corporation.
DABCO ®BL11 is a 70% solution of bis(dimethylaminoethyl)ether in dipropylene glycol commercially available from Evonik Corporation..
DABCO ®NE300 is N,N,N-trimethyl-N-3-aminopropyl-bis(aminoethyl)ether.
DABCO ®NE1550 is N,N-bis(3-dimethylaminopropyl)-N-[3-aminopropyl-N′,N′-bis(2-hydroxypropyl]amine.
PyEEAPMA is 2-[2-(1-pyrrolidinyl)ethoxy]ethyl-N-methyl-N-(3-aminopropyl)-amine as defined above.

### Example 8: Inventive

Physical Properties of Polyurethane Foam Made with Catalysts of EXAMPLE 1

Foam pads were prepared by adding a tertiary amine catalyst to about 302 g of a premix (prepared as in Table 2) in a 32 oz (951 ml) paper cup. The formulation was mixed for about 10 seconds at about 6,000 RPM using an overhead stirrer fitted with a 2-inch (5.1 cm) diameter stirring paddle. The toluene diisocyanate was then added, and the formulation was mixed well for about another 6 seconds at about 6,000 RPM using the same stirrer, after which it was poured into a pre-heated mold at 70° C. and demolded after 4 minutes. The foam pads were removed from the mold, hand crushed, weighed and machine crushed at 75% pad thickness. Foam pads were stored under constant temperature and humidity condition for 48 hours before being cut and tested.

TABLE 4
Polyurethane TDI Flexible Molded Data

| Run | Gel | Gel | Blow | Blow | Ext Time | SGT | Pad Wt | Pad Vol | Pad Vol | Density |
|---|---|---|---|---|---|---|---|---|---|---|
| # | Cat | PPHP | Cat | PPHP | (sec) | (sec) | (g) | (in³) | (cm³) | kg/m³ |
| 5 | 33LV | 0.30 | BL11 | 0.10 | 45 | 60 | 384 | 567 | 9291 | 41 |
| 6 | 33LV | 0.30 | Py- | 0.10 | 45 | 60 | 385 | 567 | 9291 | 41 |
| | | | DMAEE | | | | | | | |

Mold data performed in all cases with 0.10 pphp of blowing amine catalyst bis(dimethylaminoethyl) ether. DABCO®33LV is a 33% solution of triethylenediamine in dipropylene glycol commercially available from Evonik Corporation.

TABLE 5
Physical Properties of TDI Polyurethane Flexible Molded Foam
with 40 Kg/m³ Density and Index 100

| Physical Properties | | | | 33LV/BL11 | | 33LV/Py-DMAEE | |
|---|---|---|---|---|---|---|---|
| Test | Sample | Test Method | Test | 5 | | 6 | |
| Description | Aging | ID | Units | Avg. | Std. | Avg. | Std. |
| Core Densilty | Ambient | ASTM D3574-A | (kg/m3) | 36.66 | 0.51 | 37.90 | 0.57 |
| Section Density | Ambient | ASTM D3574-A | (kg/m3) | 42.67 | n/a | 43.34 | n/a |
| Air Flows | Ambient | ASTM D3574-G | L/M | 56.92 | 2.71 | 45.38 | 3.19 |
| ILD 25% | Ambient | ASTM D3574-B1 | N | 260.73 | n/a | 203.46 | n/a |
| ILD 65% | Ambient | ASTM D3574-B1 | N | 577.83 | n/a | 522.67 | n/a |
| ILD 25% Return | Ambient | ASTM D3574-B1 | N | 203.94 | n/a | 162.59 | n/a |
| Support Factor | Ambient | ASTM D3574-B1 | ratio | 2.22 | n/a | 2.57 | n/a |
| Resilience | Ambient | ASTM D3574-H | % | 54 | 1.0 | 56 | 0.6 |
| HALLS (70% Preflex) | Volkswagen | ISO-3386-1 | % | −31.06 | 0.63 | −27.17 | 0.29 |
| Tensile Strength | Ambient | DIN 53571 | kPa | 148.31 | 8.25 | 129.05 | 2.22 |
| Tensile Elongation | Ambient | DIN 53571 | % | 144.21 | 6.98 | 129.66 | 2.54 |
| HA Tensile Strength | Volkswagen | DIN 53571 | kPa | 110.44 | 4.97 | 120.19 | 1.21 |
| HA Elongation | Volkswagen | DIN 53571 | % | 138.05 | 5.38 | 135.86 | 7.75 |
| Tear Strength | Ambient | ASTM D3574-F | N/m | 364.54 | 13.25 | 351.42 | 12.38 |
| 50% Comp. Sets | 70° C. dry oven | ASTM D3574-D | % | 9.46 | 0.16 | 9.25 | 0.32 |
| 50% HA Comp. Sets | Volkswagen | ASTM D3574-D | % | 9.86 | 0.07 | 8.86 | 0.54 |

Table 5 shows the ambient and humid aged physical properties of flexible molded polyurethane pads made with the standard composed of blowing amine catalyst Dabco®BL11 as well as the new catalysts of EXAMPLE 1. Table 5 shows that the ambient physical properties were very similar providing foam pads with excellent physical properties. Table 5 also shows the physical properties after humid ageing. The evaluation showed the new blowing catalysts from example 1 performed similarly to a standard catalyst DABCO®BL11. Foams made using the inventive catalyst have a Tensile Strength (kPa)≥70; Elongation (%) ≥70; 50% CS (%)≤18; and a 50% HACS (%)≤18.

### Example 9: Inventive

### Flexible MDI Based Polyurethane Foam Evaluations: Rate of Rise Kinetics and Use Level Comparison for Catalysts Made in EXAMPLE 1(PyEEDMA) and EXAMPLE 6 (PyEEAPMA)

Flexible foam can be prepared by combining the ingredients shown in Table 6 following a similar procedure as outline in EXAMPLE 7.

TABLE 6
MDI-Based Premix Components

| COMPONENT | PPHP |
|---|---|
| Voranol CP-6001 | 100 |
| Dabco DC2525 | 0.90 |
| Dabco DC1630 | 0.10 |
| Voranol CP-1421 | 1.30 |
| Water | 3.49 |
| Dabco DEOA-LF | 0.71 |
| Dabco NE1550 | 0.76 |
| Dabco NE300 | 0.20 |
| MDI Index (Rubinate M) | 95 |

TABLE 7
Foam String Gel Time in Seconds

| | | Gel | | Gel | |
|---|---|---|---|---|---|
| | | Cat | Blow | Cat | SG |
| Run# | Gel Catalyst | pphp | Catalyst | pphp | (sec) |
| 7 | DABCO ®33LV | 0.30 | DABCO ®BL11 | 0.10 | 60 |
| 8 | DABCO ®33LV | 0.30 | EXAMPLE 1 | 0.10 | 60 |
| | | | (PyEEDMA) | | |
| 9 | DABCO ®NE1550 | 0.76 | DABCO ®NE300 | 0.20 | 58 |
| 10 | DABCO ®NE1550 | 0.76 | PyEEAPMA | 0.26 | 58 |

DABCO ®33LV is a 33% solution of triethylenediamine in dipropylene glycol commercially available from Evonik Corporation. DABCO ®BL11 is a 70% solution of bis(dimethylaminoethyl)ether in dipropylene glycol commercially available from Evonik Corporation.. DABCO ® NE300 is N,N,N -trimethyl-N -3- aminopropyl-bis(aminoethyl)ether. DABCO ®NE1550 is N,N-bis(3-dimethylaminopropyl)-N-[3-aminopropyl-N′,N′-bis(2-hydroxypropyl]amine. PyEEAPMA is 2-[2-(1-pyrrolidinyl)ethoxy]ethyl-N-methyl-N-(3-aminopropyl)-amine as defined above.

### Example 10: Inventive

Physical Properties of Polyurethane Foam Made with Catalysts of EXAMPLE 1

Foam pads were prepared following a similar procedure as described for TDI-based foam pads. The formulation was mixed for about 10 seconds at about 6,000 RPM using an overhead stirrer fitted with a 2-inch (5.1 cm) diameter stirring paddle. The MDI was then added, and the formulation was mixed well for about another 6 seconds at about 6,000 RPM using the same stirrer, after which it was poured into a pre-heated mold at 70° C. and demolded after 4 minutes. The foam pads were removed from the mold, hand crushed, weighed and machine crushed at 75% pad thickness. Foam pads were stored under constant temperature and humidity condition for 48 hours before being cut and tested.

TABLE 8
Polyurethane MDI Flexible Molded Data

| | | | | | Ext | | Pad | Pad | Pad | |
|---|---|---|---|---|---|---|---|---|---|---|
| Run | Gel | Gel | Blow | Blow | Time | SGT | Wt | Vol | Vol | Density |
| # | Cat | PPHP | Cat | PPHP | (sec) | (sec) | (g) | (in³) | (cm³) | kg/m³ |
| 7 | 33LV | 0.30 | BL11 | 0.10 | 58 | 69 | 490.30 | 567 | 9291 | 53 |
| 8 | 33LV | 0.30 | PyDMAEE | 0.10 | 59 | 69 | 488.68 | 567 | 9291 | 53 |

Mold data performed in all cases with 0.10 pphp of blowing amine catalyst bis(dimethylaminoethyl) ether.
DABCO ®33LV is a 33% solution of triethylenediamine in dipropylene glycol commercially available from Evonik Corporation.

TABLE 9
Physical Properties of MDI Polyurethane Flexible Molded Foam
with 50 Kg/m³ Density and Index 95

| Physical Properties | | | | 33LV/ | | 33LV/ | |
|---|---|---|---|---|---|---|---|
| Test | Sample | Test Method | Test | BL11 | | PyDMAEE | |
| Description | Aging | ID | Units | Avg. | Std. | Avg. | Std. |
| Core Densilty | Ambient | ASTM D3574-A | (kg/m³) | 52.19 | 0.51 | 51.75 | 1.07 |
| Section Density | Ambient | ASTM D3574-A | (kg/m³) | 54.48 | n/a | 54.92 | n/a |
| Air Flows | Ambient | ASTM D3574-G | L/M | 52.11 | 3.81 | 46.80 | 5.25 |
| ILD 25% | Ambient | ASTM D3574-B1 | N | 337.47 | n/a | 330.64 | n/a |
| ILD 65% | Ambient | ASTM D3574-B1 | N | 847.34 | n/a | 835.95 | n/a |
| ILD 25% Return | Ambient | ASTM D3574-B1 | N | 254.57 | n/a | 249.83 | n/a |
| Support Factor | Ambient | ASTM D3574-B1 | ratio | 2.51 | n/a | 2.53 | n/a |
| Resilience | Ambient | ASTM D3574-H | % | 41 | 0.0 | 41 | 0.6 |
| HALLS (70% Preflex) | Volkswagen | ISO-3386-1 | % | −26.22 | 0.72 | −26.41 | 3.43 |
| Tensile Strength | Ambient | DIN 53571 | kPa | 148.38 | 8.80 | 152.89 | 5.90 |
| Tensile Elongation | Ambient | DIN 53571 | % | 130.44 | 5.71 | 137.79 | 6.17 |
| HA Tensile Strength | Volkswagen | DIN 53571 | kPa | 128.22 | 6.11 | 129.22 | 5.37 |
| HA Elongation | Volkswagen | DIN 53571 | % | 110.55 | 5.33 | 116.60 | 4.64 |
| Tear Strength | Ambient | ASTM D3574-F | N/m | 286.19 | 14.16 | 286.25 | 17.33 |
| 50% Comp. Sets | 70° C. dry oven | ASTM D3574-D | % | 7.32 | 0.53 | 7.05 | 0.19 |
| 50% HA Comp. Sets | Volkswagen | ASTM D3574-D | % | 13.36 | 0.26 | 9.77 | 0.24 |

### Example 11: Inventive

### Evaluation of DMF and Color During Air Exposure

A sample of 50 g of catalyst 2-[2-(1-pyrrolidinyl)ethoxy]ethyl-N-methyl-N-(3-aminopropyl)-amine (PyEEAPMA) prepared in example 6 was placed in a 500 ml glass jar and left open for about a minute. The sample in the jar was capped with the lid loose to allow air movement and it was placed in an oven at 50° C. The head space volume of air above the sample was similar to the volume of the jar. A similar sample was also prepared with a standard non-emissive catalyst N,N,N-trimethyl-N-3-aminopropyl-bis(aminoethyl)ether. Samples were analyzed as a 2.5% solution in methanol. External DMF standards were prepared in methanol and ranged in concentration from 0.8-50 ppm. The DMF responded best using GC/MS with single ion monitoring (SIM). SIM focuses on specified ions that are known to fragment from a known component. In this analysis, ions 58, 72 and 73 were monitored. The analysis was completed on an Agilent 7890 gas chromatograph that utilized a 60-meter Restek Rtx-624 capillary column.

| | DMF Levels (ppm) | | | |
|---|---|---|---|---|
| | | 2 d at | 4 d at | 7 d at |
| Catalyst | Initial | 50 C | 50 C | 50 C |
| N,N,N -trimethyl-N -3- aminopropyl- | 65.1 | 267.3 | 324.0 | 349.3 |
| bis(aminoethyl)ether | | | | |
| PyEEAPMA | ND | ND | ND | ND |

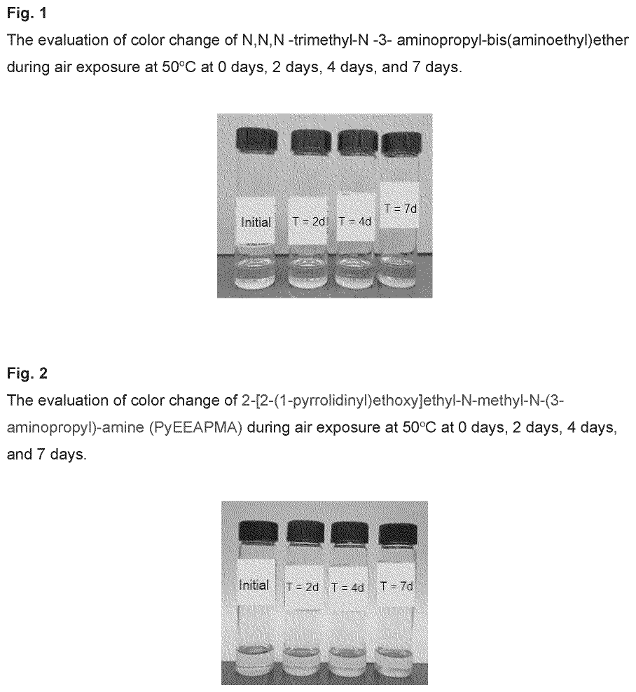

No DMF was detected for PyEEAPMA while the standard catalysts N,N,N-trimethyl-N-3-aminopropyl-bis(aminoethyl)ether showed a constant increase of DMF over time. Thus it is reasonable to assume that the DMF concentration in PyEEAPMA is 0 to ≤40 ppm. Furthermore, while N,N,N-trimethyl-N-3-aminopropyl-bis(aminoethyl)ether showed a significant color change from colorless to deep yellow/amber under air at 50° C. (see FIG. 1), PyEEAPMA showed essentially no change in color under the same conditions (see FIG. 2).

While the invention has been described with reference to certain aspects or embodiments, it will be understood by those skilled in the art that various changes may be made and equivalents may be substituted for elements thereof without departing from the scope of the invention. In addition many modifications may be made to adapt the teachings of the invention without departing from the essential scope thereof. Therefore it is intended that the invention not be limited to the particular embodiment disclosed as the best mode contemplated for carrying out this invention but that the invention will include all embodiments falling within the scope of the appended claims.

### Example #12: Prophetic

Vapor Phase Amination of Diethylene Glycol (DEG) with Pyrrolidine (Py) to Give 2-[2-(1-pyrrolidinyl)ethoxy]ethanol (PyEE)

A fixed bed tubular reactor equipped with a 10-cc quartz preheat bed is charged with 27.15 g of a metal supported catalyst with an approximate composition of 50-70 wt. % CuCr₂O₄, 20-30% CuO, 20-30 wt. % BaCr₂O₄, CrO₃ 1-5 wt. %. The reactor is pressurized with nitrogen to 75 psig, and then vented to ambient pressure. The reactor pressure is maintained by means of a backpressure controller. The nitrogen purge is repeated two additional cycles to inert and leak test the reactor. The reactor is pressurized to 75 psig and nitrogen is fed at 200 ml/min. Then the reactor is heated with a resistance heater to 175° C. at a temperature ramp of 30° C. per hour or less. Once the temperature is stabilized at 175° C., hydrogen and nitrogen is fed with a total flow rate of 200 ml/min and the hydrogen concentration was less than 5%. These conditions are held for at least 12 h. The reactor temperature is then increased to 200° C. at a temperature ramp of 10° C. per hour or less. Once the temperature is stabilized at 200° C., the hydrogen was slowly increased to at least 10% with a total flow rate of 200 ml/min. These conditions are kept for at least 2 h to complete catalyst activation. The reactor is then conditioned to about 190° C. and about 60 psig and Diethylene Glycol (DEG) is fed to the reactor under pressure via a constant flow syringe pump. The hydrogen flow is metered via a mass flow controller, which is adjusted to provide a 4/1 molar ratio of Hydrogen/DEG. Pyrrolidine (Py) is co-fed to the reactor under pressure (about reactor pressure or greater), via a constant flow syringe pump at a Py/DEG molar ratio of 2/1. Effluent from the reactor is analyzed by gas chromatography (GC). After several GC samples, the composition of the mixture remains unchanged over time. Recovered product is clear to light yellow in color, and elemental analysis shows that chromium leaching does not occur to any appreciable extent. Analysis of the effluent by GC and GCMS confirms the formation of 2-[2-(1-pyrrolidinyl)ethoxy]ethanol (PyEE). PyEE yield selectivity is about 65%. DEG conversion is about 80% with the main byproduct being bis(2-pyrrolidinylethyl)ether which is recovered by distillation. These results indicate that PyEE can be produced with good yield in a vapor phase amination of DEG with Py in a continuous fixed bed reactor.

1. A catalyst composition comprising at least one tertiary amine with the formula: 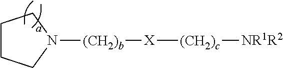
where a=1 or 2; b and c are independently 2 or 3; and X═O or N—CH₃; and R¹═R²═CH₃, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

2. The catalyst composition of claim 1 wherein the at least one tertiary amine is selected from the group consisting of 2-[2-(1-pyrrolidinyl)ethoxy]ethyl-N,N-dimethyl amine; 2-[2-(1-pyrrolidinyl)ethoxy]ethyl-N-methyl-N-ethyl-amine; 2-[2-(1-pyrrolidinyl)ethoxy]ethyl-N-methyl-N-propyl-amine; 2-[2-(1-pyrrolidinyl)ethoxy]ethyl-N-methyl-N-isopropyl-amine; 2-[2-(1-pyrrolidinyl)ethoxy]ethyl-N-methyl-N-(n-butyl)-amine; 2-[2-(1-pyrrolidinyl)ethoxy]ethyl-N-methyl-N-(sec-butyl)-amine; 2-[2-(1-pyrrolidinyl)ethoxy]ethyl-N-methyl-N-(iso-butyl)-amine; 2-[2-(1-pyrrolidinyl)ethoxy]propyl-N,N-dimethyl amine; 2-[2-(1-pyrrolidinyl)ethoxy]propyl-N-methyl-N-ethyl-amine; 2-[2-(1-pyrrolidinyl)ethoxy]propyl-N-methyl-N-propyl-amine; 2-[2-(1-pyrrolidinyl)ethoxy]propyl-N-methyl-N-isopropyl-amine; 2-[2-(1-pyrrolidinyl)ethoxy]propyl-N-methyl-N-(n-butyl)-amine; 2-[2-(1-pyrrolidinyl)ethoxy]propyl-N-methyl-N-(sec-butyl)-amine; 2-[2-(1-pyrrolidinyl)ethoxy]propyl-N-methyl-N-(iso-butyl)-amine; 2-[2-(1-pyrrolidinyl)propoxy]ethyl-N,N-dimethyl amine; 2-[2-(1-pyrrolidinyl)propoxy]ethyl-N-methyl-N-ethyl-amine; 2-[2-(1-pyrrolidinyl)propoxy]ethyl-N-methyl-N-propyl-amine; 2-[2-(1-pyrrolidinyl)propoxy]ethyl-N-methyl-N-isopropyl-amine; 2-[2-(1-pyrrolidinyl)propoxy]ethyl-N-methyl-N-(n-butyl)-amine; 2-[2-(1-pyrrolidinyl)propoxy]ethyl-N-methyl-N-(sec-butyl)-amine; 2-[2-(1-pyrrolidinyl)propoxy]ethyl-N-methyl-N-(iso-butyl)-amine; 2-[2-(1-pyrrolidinyl)propoxy]propyl-N,N-dimethyl amine; 2-[2-(1-pyrrolidinyl)propoxy]propyl-N-methyl-N-ethyl-amine; 2-[2-(1-pyrrolidinyl)propoxy]propyl-N-methyl-N-propyl-amine; 2-[2-(1-pyrrolidinyl)propoxy]propyl-N-methyl-N-isopropyl-amine; 2-[2-(1-pyrrolidinyl)propoxy]propyl-N-methyl-N-(n-butyl)-amine; 2-[2-(1-pyrrolidinyl)propoxy]propyl-N-methyl-N-(sec-butyl)-amine; 2-[2-(1-pyrrolidinyl)propoxy]propyl-N-methyl-N-(iso-butyl)-amine; 2-[2-(1-pyrrolidinyl)ethoxy]ethyl-N-methyl-N-(2-cyanoethyl)-amine; 2-[2-(1-pyrrolidinyl)ethoxy]ethyl-N-methyl-N-(3-aminopropyl)-amine; 2-[2-(1-pyrrolidinyl)ethoxy]ethyl-N-methyl-N-(2-aminoethyl)-amine; 2-[2-(1-pyrrolidinyl)ethoxy]propyl-N-methyl-N-(2-cyanoethyl)-amine: 2-[2-(1-pyrrolidinyl)ethoxy]propyl-N-methyl-N-(3-aminopropyl)-amine; 2-[2-(1-pyrrolidinyl)ethoxy]propyl-N-methyl-N-(2-aminoethyl)-amine; 2-[2-(1-pyrrolidinyl)propoxy]propyl-N-methyl-N-(3-aminopropyl)-amine; 2-[2-(1-pyrrolidinyl)propoxy]propyl-N-methyl-N-(2-aminoethyl)-amine; 2-[2-(1-pyrrolidinyl)propoxy]ethyl-N-methyl-N-(3-aminopropyl)-amine; 2-[2-(1-pyrrolidinyl)propoxy]ethyl-N-methyl-N-(2-aminoethyl)-amine; 2-[2-(1-pyrrolidinyl)ethoxy]ethyl-N-methyl-N-(2-cyanoethyl)-amine; 2-[2-(1-pyrrolidinyl)ethoxy]ethyl-N-(2-cyanoethyl)-amine; 2-[2-(1-pyrrolidinyl)ethoxy]propyl-N-methyl-N-(2-cyanoethyl)-amine; 2-[2-(1-pyrrolidinyl)ethoxy]propyl-N-(2-cyanoethyl)-amine; 2-[2-(1-pyrrolidinyl)propoxy]propyl-N-methyl-N-(2-cyanoethyl)-amine; 2-[2-(1-pyrrolidinyl)propoxy]propyl-N-(2-aminoethyl)-amine; 2-[2-(1-pyrrolidinyl)propoxy]ethyl-N-methyl-N-(2-cyanoethyl)-amine; 2-[2-(1-pyrrolidinyl)propoxy]ethyl]-N-(2-aminoethyl)-amine, 2-[2-(1-piperidinyl)ethoxy]ethyl-N,N-dimethyl amine; 2-[2-(1-piperidinyl)ethoxy]ethyl-N-methyl-N-ethyl-amine; 2-[2-(1-piperidinyl)ethoxy]ethyl-N-methyl-N-propyl-amine; 2-[2-(1-piperidinyl)ethoxy]ethyl-N-methyl-N-isopropyl-amine; 2-[2-(1-piperidinyl)ethoxy]ethyl-N-methyl-N-(n-butyl)-amine; 2-[2-(1-piperidinyl)ethoxy]ethyl-N-methyl-N-(sec-butyl)-amine; 2-[2-(1-piperidinyl)ethoxy]ethyl-N-methyl-N-(iso-butyl)-amine; 2-[2-(1-piperidinyl)ethoxy]propyl-N,N-dimethyl amine; 2-[2-(1-piperidinyl)ethoxy]propyl-N-methyl-N-ethyl-amine; 2-[2-(1-piperidinyl)ethoxy]propyl-N-methyl-N-propyl-amine; 2-[2-(1-piperidinyl)ethoxy]propyl-N-methyl-N-isopropyl-amine; 2-[2-(1-piperidinyl)ethoxy]propyl-N-methyl-N-(n-butyl)-amine; 2-[2-(1-piperidinyl)ethoxy]propyl-N-methyl-N-(sec-butyl)-amine; 2-[2-(1-piperidinyl)ethoxy]propyl-N-methyl-N-(iso-butyl)-amine; 2-[2-(1-piperidinyl)propoxy]ethyl-N,N-dimethyl amine; 2-[2-(1-piperidinyl)propoxy]ethyl-N-methyl-N-ethyl-amine; 2-[2-(1-piperidinyl)propoxy]ethyl-N-methyl-N-propyl-amine; 2-[2-(1-piperidinyl)propoxy]ethyl-N-methyl-N-isopropyl-amine; 2-[2-(1-piperidinyl)propoxy]ethyl-N-methyl-N-(n-butyl)-amine; 2-[2-(1-piperidinyl)propoxy]ethyl-N-methyl-N-(sec-butyl)-amine; 2-[2-(1-piperidinyl)propoxy]ethyl-N-methyl-N-(iso-butyl)-amine; 2-[2-(1-piperidinyl)propoxy]propyl-N,N-dimethyl amine; 2-[2-(1-piperidinyl)propoxy]propyl-N-methyl-N-ethyl-amine; 2-[2-(1-piperidinyl)propoxy]propyl-N-methyl-N-propyl-amine; 2-[2-(1-piperidinyl)propoxy]propyl-N-methyl-N-isopropyl-amine; 2-[2-(1-piperidinyl)propoxy]propyl-N-methyl-N-(n-butyl)-amine; 2-[2-(1-piperidinyl)propoxy]propyl-N-methyl-N-(sec-butyl)-amine; 2-[2-(1-piperidinyl)propoxy]propyl-N-methyl-N-(iso-butyl)-amine; 2-[2-(1-piperidinyl)ethoxy]ethyl-N-methyl-N-(3-aminopropyl)-amine; 2-[2-(1-piperidinyl)ethoxy]ethyl-N-methyl-N-(2-aminoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-methyl-N-(3-aminopropyl)-amine; 2-[2-(1-piperidinyl)ethoxy]propyl-N-methyl-N-(2-aminoethyl)-amine; 2-[2-(1-piperidinyl)propoxy]propyl-N-methyl-N-(3-aminopropyl)-amine; 2-[2-(1-piperidinyl)propoxy]propyl-N-methyl-N-(2-aminoethyl)-amine; 2-[2-(1-piperidinyl)propoxy]ethyl-N-methyl-N-(3-aminopropyl)-amine; 2-[2-(1-piperidinyl)propoxy]ethyl-N-methyl-N-(2-aminoethyl)-amine; 2-[2-(1-piperidinyl)ethoxy]ethyl-N-methyl-N-(2-cyanoethyl)-amine; 2-[2-(1-piperidinyl)ethoxy]ethyl-N-(2-cyanoethyl)-amine; 2-[2-(1-piperidinyl)ethoxy]propyl-N-methyl-N-(2-cyanoethyl)-amine; 2-[2-(1-piperidinyl)ethoxy]propyl-N-(2-cyanoethyl)-amine; 2-[2-(1-piperidinyl)propoxy]propyl-N-methyl-N-(2-cyanoethyl)-amine; 2-[2-(1-piperidinyl)propoxy]propyl-N-(2-aminoethyl)-amine; 2-[2-(1-piperidinyl)propoxy]ethyl-N-methyl-N-(2-cyanoethyl)-amine; and 2-[2-(1-piperidinyl)propoxy]ethyl]-N-(2-aminoethyl)-amine.

3. The catalyst composition of claim 2 further comprising a gelling co-catalyst selected from the group consisting of N,N-bis(3-dimethylaminopropyl)-N-(2-hydroxypropyl) amine; N,N-dimethyl-N′,N′-bis(2-hydroxypropyl)-1,3-propylenediamine; dimethylaminopropylamine (DMAPA); N-methyl-N-2-hydroxypropyl-piperazine, bis-dimethylaminopropyl amine (POLYCAT® 15), dimethylaminopropyl urea and N,N′-bis(3-dimethylaminopropyl) urea (DABCO® NE1060, DABCO® NE1070, DABCO® NE1080 and DABCO® NE1082), 1,3-bis(dimethylamino)-2-propanol, 6-dimethylamino-1-hexanol, N-(3-aminopropyl)imidazole, N-(2-hydroxypropyl)imidazole, N,N′-bis(2-hydroxypropyl) piperazine, N-(2-hydroxypropyl)-morpholine, N-(2-hydroxyethylimidazole), N,N′-bis(2-hydroxypropyl) piperazine, N-(2-hydroxypropyl)-morpholine, N-(2-hydroxyethylimidazole), 2-hydroxymethyl-1,4-diazabicyclo[2.2.2]octane, N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; N,N-bis(3-dimethylaminopropyl)-N-[(2-hydroxypropyl)-3-aminopropyl]amine; N,N-bis(dimethylaminopropyl)-N-(3-aminopropyl)-amine; N,N′-bis[bis-N″,N″-(3-dimethylaminopropyl)-N″-(3-aminopropyl)]urea; N,N-bis(3-dimethylaminopropyl)-N-(3-aminopropyl)]urea; N,N-bis(3-dimethylaminopropyl)-N-(bis(2-hydroxypropyl)-3-aminopropyl)]amine; N,N-bis(3-dimethylaminopropyl)-N—[N′,N′-bis(2-hydroxypropyl)-3-aminopropyl]amine; and N,N-bis(3-dimethylaminopropyl)-N-[(2-hydroxypropyl)-3-aminopropyl]amine.

4. The catalyst composition of claim 3 further comprising a blowing co-catalyst selected from the group consisting of N,N,N′-trimethyl-N′-3-aminopropyl-bis(aminoethyl) ether, 2-[N-(dimethylaminoethoxyethyl)-N-methylamino]ethanol and N,N,N′-trimethyl-N′-(2-hydroxyethyl)-bis(aminoethyl) ether.

5. The catalyst composition of claim 1 wherein the catalyst composition has a dimethylformamide concentration between 0 ppm to 40 ppm.

6. A method for the manufacturing of a catalyst composition comprising at least one tertiary amine with the formula: 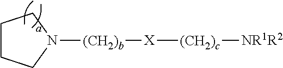
where a=1 or 2; b and c are independently 2 or 3; and X═O or N—CH₃; and R¹═R²═CH₃, or R¹═CH₃ and R²═H, or R¹═CH₃ and R²═—(CH₂)_{d}—NH₂ and d=2 or 3, or R¹═CH₃ and R²═—(CH₂)₂CN, or R¹═H and R²═—(CH₂)₂CN, or R¹ and R²═—(CH₂)₂CN.

7. The method of claim 6 wherein X═O and the method comprises converting cyclic-amines to cycloamino-alkylether amines by the following reaction sequence: a) alkoxylation of a cyclic-amine to give cycloamine-alkoxyalcohol; and b) conversion of the cycloamine-alkoxyalcohol to the cycloamine-alkoxy-alkylamine.

8. The method of claim 6 wherein X═N—CH₃ and the method comprises converting cyclic amines to cycloamino-alkylether-amine-nitriles and to cycloamino-alkylether-amines having a primary or secondary amine functionality by the following reaction sequence: a) alkoxylation of a cyclic-amine to give cycloamine-alkoxyalcohol; b) conversion of the cycloamine-alkoxyalcohol to the cycloamine-alkoxy-alkylamine; c) conversion of the cycloamine-alkoxy-alkylamine to cycloamino-alkylether-amine-nitriles; d) conversion of the cycloamino-alkyl-ether-amine-nitriles to cycloamino-alkyl-ether amine having a primary amine functionality.

9. A method for making a polyurethane foam comprising reacting at least one isocyanate and at least one polyol in the presence of the catalyst composition of claim 1.

10. The method of claim 9 further comprising reacting at least one gelling co-catalyst.

11. The method of claim 10 further comprising reacting a blowing co-catalyst.

12. A polyurethane foam formulation comprising at least one polyol component, at least one isocyanate component, and the catalyst composition of claim 1.
